(19) United States
(12) Patent Application Publication
(10) Pub. No.: US 2002/0107303 A1
(43) Pub. Date: Aug. 8, 2002

(54) Method of preparation of polymer emulsion and ink composition comprising the polymer emulsion

(75) Inventors: Toshiyuki Miyabashi, Nagano-ken (JP); Masahiro Yatake, Nagano-ken (JP)

Correspondence Address: William R. Evans, Ladas & Parry, 26 West 61 Street, New York, NY, 10023, US

(73) Assignee: SEIKO EPSON CORPORATION

(21) Appl. No.: 09/976,671

(22) Filed: Oct. 12, 2001

(30) Foreign Application Priority Data
Oct. 12, 2000 (JP) 2000-312435
Oct. 25, 2000 (JP) 2000-325248
Jul. 5, 2001 (JP) 2001-205223

(51) Int. Cl. C08K 3/00; C09D 5/00

(52) U.S. Cl. 523/160; 524/800; 523/161

(57) ABSTRACT

An object of the present invention is to provide a production process of a polymer emulsion which can improve the printing stability and ejection stability of an ink composition. The object can be attained by a production process comprising the steps of: mixing water, a monomer, an emulsifier, and a polymerization initiator together to allow emulsion polymerization to proceed; and then adding a monovalent inorganic hydroxide to adjust the resultant polymer emulsion to a desired pH value.

### BACKGROUND OF THE INVENTION

1. Field of the Invention

The present invention relates to a process for producing a polymer emulsion, and more particularly to a process for producing a polymer emulsion for use in ink compositions.

2. Background Art

Ink jet recording is a method wherein ink is ejected as droplets through fine nozzles to record letters or figures onto the surface of recording media. Inks comprising various water-soluble dyes dissolved in aqueous media have generally been used for ink jet recording. Inks comprising pigments dispersed in aqueous media have also been provided. Inks comprising pigments dispersed in aqueous media are advantageously superior to inks using water-soluble dyes in waterfastness and lightfastness of printed images.

In printing a pigment-containing ink on recording media, on the other hand, the pigment as a colorant which is not satisfactorily fixed onto the recording media gives smeared images with external force rubbing. Thus, pigment-containing inks are required for the pigment as the colorant to be strongly fixed onto recording media and consequently to yield prints having excellent rubbing/scratch resistance.

In order to improve the fixation of the pigment as the colorant onto recording media, the addition of a resin to ink compositions has been proposed. For example, Japanese Patent Publication No. 1426/1987 discloses an ink comprising a pigment and a resin emulsion dispersed in water; Japanese Patent Laid-Open No. 157668/1980 discloses the dispersion of a pigment in a water-insoluble resin emulsion; Japanese Patent Laid-Open No. 217088/1989 discloses the use of an emulsion having a specific film-forming temperature; and likewise, Japanese Patent Laid-Open Nos. 60068/1991 and 18462/1992 disclose an ink using a resin emulsion. Further, in Japanese Patent Laid-Open No. 259869/1996, studies have been made on the use of core/shell-type resin particles, comprising a core and a shell surrounding the core, in inks for ink jet recording.

Some of these ink compositions comprising resin emulsions, however, have been found to have high viscosity which renders the ink compositions unsuitable for ink jet recording method. Further, a nozzle plate of an ink jet recording head has been sometimes subjected to water repellency-imparting treatment so that ink droplets could be easily ejected through nozzles. Ink compositions using, as an additive, resin emulsions, which are commercially available for use as coating materials and adhesives and comprise fine particles of a polymer having a conventional polymer structure, however, are highly likely to wet the nozzle plate. This has led to the occurrence of ink droplet trajectory directionality problems and a failure of the ink droplets to be ejected. In order to realize fast drying of prints, for example, glycol ethers or surfactants, such as acetylene glycol surfactants, are sometimes incorporated as penetrating agents into inks. Upon mixing of these penetrating agents with some type of resin emulsion, however, an unfavorable phenomenon sometimes occurs such that the fine particles of a polymer constituting the resin emulsion are swollen, and, consequently, this has led to unsatisfactory ejection stability of ink and long-term storage stability of ink.

The resin emulsion is produced by mixing water, an emulsifier, and a polymerization initiator together and allowing a polymerization reaction to proceed under proper conditions. The produced resin emulsion is generally acidic and, thus, as such often causes an increase in viscosity and coagulation. To overcome this problem, in the prior art, a method has been adopted wherein aqueous ammonia is added to the produced resin emulsion to adjust pH, thereby stabilizing the resin emulsion per se. Storage of the resin emulsion, which has been neutralized with aqueous ammonia, for a long period of time, however, caused lowered pH and increased viscosity. Storage of ink compositions using this resin emulsion for a long period of time also caused lowered pH and increased viscosity. Thus, this resin emulsion often affected ejection stability.

### SUMMARY OF THE INVENTION

The present inventor has now found that, in the production of a polymer emulsion comprising fine particles of a polymer, a polymer emulsion having improved storage stability can be realized by mixing water, a monomer, an emulsifier, and a polymerization initiator together, emulsion polymerizing the mixture, and then adjusting pH of the resultant polymer emulsion to neutral or alkaline by the addition of a monovalent inorganic hydroxide. The present inventor has further found that the addition of the polymer emulsion produced according to the present invention to an ink composition can improve storage stability, anti-clogging properties, and ejection stability of the ink composition and images of prints produced by this ink composition have high firmness and rubbing/scratch resistance. The present invention has been made based on such finding.

Accordingly, it is an object of the present invention to provide a process for producing a polymer emulsion comprising fine particles of a polymer which can improve the fixation of a pigment printed on recording media and can realize images having excellent rubbing/scratch resistance.

According to one aspect of the present invention, there is provided a process for producing a polymer emulsion comprising fine particles of a polymer, said process comprising the steps of:

mixing water, a monomer, an emulsifier, and a polymerization initiator together to allow emulsion polymerization to proceed; and

adjusting pH of the resultant polymer emulsion to neutral or alkaline by adding a monovalent inorganic hydroxide.

According to another aspect of the present invention, there is provided an ink composition comprising a pigment, a polymer emulsion, water, and a water-soluble organic solvent, the polymer emulsion having been produced by the production process according to the present invention.

### BRIEF DESCRIPTION OF THE DRAWING

FIG. 1 shows a ruled line pattern for measuring the ejection stability of an ink for ink jet recording.

### DETAILED DESCRIPTION OF THE INVENTION

### Definition

The term “polymer emulsion” refers to an aqueous dispersion comprising water as a continuous phase and fine particles of a polymer as dispersed particles. The “polymer emulsion” is often called a “resin emulsion.”The term “fine particles of a polymer” refers to fine particles of the polymer component. Specific examples of the polymer component constituting the fine particles of the polymer include styrene/(meth)acrylic acid copolymers, styrene/(meth)acrylic ester/(meth)acrylic acid copolymers, poly(meth)acrylic esters, styrene/butadiene copolymers, polybutadiene, acrylonitrile/butadiene copolymers, chloroprene copolymers, polyolefins, polystyrene, polyvinyl acetate, polyamides, ethylene/vinyl acetate copolymers, vinyl acetate/acrylic ester copolymers, and polyurethanes.

### Production Process of Polymer Emulsion

a) Monomer

In the present invention, the monomer is preferably an unsaturated vinyl monomer. Specific examples of unsaturated vinyl monomers include those commonly used in emulsion polymerization, such as acrylic ester monomers, methacrylic ester monomers, aromatic vinyl monomers, vinyl ester monomers, vinyl cyanide compound monomers, halogenated monomers, olefin monomers, and diene monomers. Specific examples thereof include: acrylic esters, such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, and glycidyl acrylate; methacrylic esters, such as methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, and glycidyl methacrylate; vinyl esters, such as vinyl acetate; vinyl cynide compounds, such as acrylonitrile and methacrylonitrile; halogenated monomers, such as vinylidene chloride and vinyl chloride; aromatic vinyl monomers, such as styrene, 2-methylstyrene, vinyltoluene, t-butylstyrene, chlorostyrene, vinylanisole, and vinylnaphthalene; olefins, such as ethylene, propylene, and isopropylene; dienes, such as butadiene and chloroprene; and vinyl monomers, such as vinyl ether, vinyl ketone, and vinylpyrrolidone. In the case of monomers not having a carboxyl group, the utilization of a carboxyl-containing unsaturated vinyl monomer is indispensable. Examples of preferred carboxyl-containing unsaturated vinyl monomers include acrylic acid, methacrylic acid, itaconic acid, fumaric acid, and maleic acid. Among them, methacrylic acid is more preferred.

Further, in the present invention, a structure formed by crosslinking of molecules, derived from the above monomers, with a crosslinkable monomer having two or more polymerizable double bonds is preferred. Examples of crosslinkable monomers having two or more polymerizable double bonds include: diacrylate compounds, such as polyethylene glycol diacrylate, triethylene glycol diacrylate, 1,3-butylene glycol diacrylate, 1,6-butylene glycol diacrylate, 1,6-hexanediol diacrylate, neopentyl glycol diacrylate, 1,9-nonanediol diacrylate, polypropylene glycol diacrylate, 2,2′-bis(4-acryloxypropyloxyphenyl) propane, and 2,2′-bis(4-acryloxydiethoxyphenyl) propane; triacrylate compounds, such as trimethylolpropane triacrylate, trimethylolethane triacrylate, and tetramethylolmethane triacrylate; tetraacrylate compounds, such as ditrimethylol tetraacrylate, tetramethylolmethane tetraacrylate, and pentaerythritol tetraacrylate; hexaacrylate compounds, such as dipentaerythritol hexaacrylate; dimethacrylate compounds, such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate, and 2,2′-bis(4-methacryloxydiethoxyphenyl)propane; trimethacrylate compounds, such as trimethylolpropane trimethacrylate and trimethylolethane trimethacrylate; methylene bisacrylamide; and divinylbenzene.

The addition of acrylamides or hydroxyl-containing monomers besides the above monomers can further improve printing stability. Specific examples of acrylamides include acrylamide and N,N'-dimethylacrylamide. Specific examples of hydroxyl-containing monomers include 2-hydroxyethyl acrylate, 2-hydroxypropyl acrylate, 2-hydroxyethyl methacrylate, and 2-hydroxypropyl methacrylate. They may be used solely or as a mixture of two or more.

b) Emulsifier, Polymerization Initiator, and Other Ingredients

Specific examples of emulsifiers include: anionic surfactants, such as salts of alkylallylsulfonic acids or salts of alkylallylsulfuric acids, salts of alkylsulfonic acids or salts of alkylsulfuric acids, and salts of dialkylsulfosuccinic acids; and nonionic surfactants, such as polyoxyethylene nonylphenyl ether, polyoxyethylenestearic esters, polyoxyethylene alkylallyl ethers, and sorbitan monolauric esters. Further, in the present invention, “emulsifier” embraces a protective colloid. Specific examples of protective colloids include polyvinyl alcohol, polyvinylpyrrolidone, gum arabic, tragacanth, and gelatin.

Polymerization initiators include potassium persulfate and ammonium persulfate. Other ingredients usable herein include polymerization regulators, chain transfer agents, and molecular weight modifiers.

c) Emulsion Polymerization and Reaction Conditions

The fine particles of a polymer may be produced by mixing a monomer, an emulsifier, a polymerization initiator, and other optional ingredients together and emulsion polymerizing the mixture. The amounts of these ingredients added may be properly determined. The emulsion polymerization reaction temperature is 60 to 90° C., preferably about 70 to 80° C.

The fine particles of a polymer having a core/shell structure described later may be produced by a conventional method, generally by multi-stage emulsion polymerization, for example, by a method disclosed in Japanese Patent Laid-Open No. 76004/1992. Specific examples of unsaturated vinyl monomers used in the polymerization include those described above.

Methods for introducing an epoxy group into the core portion include a method wherein an epoxy containing unsaturated vinyl monomer, such as glycidyl acrylate, glycidyl methacrylate, or allyl glycidyl ether, is copolymerized with other unsaturated vinyl monomer, and a method wherein, in the polymerization of at least one unsaturated vinyl monomer to prepare core particles, an epoxy compound is simultaneously added to form a composite structure. The former method is preferred from the viewpoints of easiness of the polymerization, polymerization stability and the like.

d) pH Adjustment

According to the present invention, pH of the polymer emulsion, which has been produced by the above emulsion polymerization, is adjusted to a neutral or alkaline pH value by the addition of a monovalent inorganic hydroxide.

Specific examples of monovalent inorganic hydroxides usable in the present invention include monovalent metal hydroxides, and preferred are alkali metal hydroxides. Among alkali metal hydroxides, one member or a mixture of two or more members selected from the group consisting of lithium hydroxide (LiOH), sodium hydroxide (NaOH), and potassium hydroxide (KOH) is particularly preferred.

The pH value is adjusted to a neutral or alkaline pH value, preferably to a pH range of about 7 to 10, more preferably a pH range of about 7 to 9. Therefore, the amount of the monovalent inorganic hydroxide added may be such that the polymer emulsion is brought to the above-defined pH range.

e) Production Process

The production process of the polymer emulsion will be briefly described. Water and an emulsifier are charged into a reaction vessel equipped, for example, with a stirrer, a reflux condenser, a dropping device, and a thermometer, a polymerization initiator is added to the reaction vessel, and the temperature of the contents of the reaction vessel is then regulated to a predetermined value. An emulsified monomer is then added to this reaction vessel, and a reaction is allowed to proceed to prepare a polymer emulsion which is then adjusted to a desired pH value by the addition of a monovalent inorganic hydroxide. Thus, the polymer emulsion according to the present invention is produced.

### Polymer Emulsion

In the polymer emulsion produced by the present invention, the ratio of the fine particles of a polymer to water is approximately in the range of 1:1 to 1:4, preferably approximately in the range of 1:1 to 1:3. According to a preferred embodiment of the present invention, the fine particles of a polymer comprise a polymer component having both hydrophilic and hydrophobic portions. The weight average molecular weight of the fine particles of a polymer is not less than about 10,000. The average particle diameter of the fine particles of a polymer is preferably not more than about 400 nm, more preferably about 10 to 200 nm, still more preferably about 50 to 200 nm.

According to a preferred embodiment of the present invention, the glass transition point of the fine particles of a polymer is about 30° C. or below, preferably about 25° C. or below, more preferably about 20° C. or below.

According to a preferred embodiment of the present invention, the minimum film-forming temperature of the polymer emulsion is about 30° C. or below, preferably room temperature (about 25° C.) or below, more preferably about 20° C. or below. The formation of a film of the fine particles of a polymer at 30° C. or below is preferred, because, without the necessity of heating and drying the printed recording medium, the film formation on the printing surface proceeds automatically at room temperature or below and the pigment is strongly fixed on recording media. The term “minimum film-forming temperature” used herein refers to a minimum temperature at which, when a polymer emulsion prepared by dispersing fine particles of a polymer in water is thinly cast onto a sheet of a metal, such as aluminum, to form a coating which is then gradually heated, a transparent, continuous film is formed. In this case, a white powder is formed in a temperature range below the minimum film-forming temperature.

The term “film-forming property” used herein means that evaporating the water component, as a continuous phase, of a polymer emulsion of the fine particles of a polymer dispersed in water results in the formation of a polymer film. Likewise, the ink composition with the fine particles of a polymer added thereto has a property such that evaporating water or the aqueous organic solvent from the periphery of the fine particles of the polymer results in the formation of a polymer film.

According to a preferred embodiment of the present invention, the fine particles of a polymer have carboxyl groups on the surface thereof and, in addition, together with a divalent metal salt, are highly likely to form coagulate.

More specifically, the capability of the fine particles of a polymer, together with a divalent metal salt, to form coagulate is such that, when 3 volumes of a 0.1 wt % polymer emulsion of the fine particles of a polymer is brought into contact with one volume of a 1 mol/liter aqueous divalent metal salt solution, the time required for the transmittance of light having a wavelength of 700 nm to become 50% of the initial transmittance value is not more than 1×10⁴ sec, preferably not more than 1×10³ sec, more preferably not more than 1×10² sec. The fine particles of a polymer, when brought into contact with divalent metal ions, form coagulate to produce suspended matter which lowers the transparency of the solution. The amount of the resultant suspended matter is measured in terms of light transmittance. Divalent metal ions include Ca²⁺, Cu²⁺, Ni²⁺, Mg²⁺, Zn²⁺, and Ba²⁺. Anions, which form salts with divalent metal ions, include Cl⁻, NO³⁻, I⁻, Br³¹ , ClO⁻, and CH₃COO⁻. This high capability of forming coagulate is considered attributable to the presence of a relatively large amount of carboxyl groups on the surface of the fine particles of the polymer. Ink compositions containing fine particles of a polymer having, on the surface thereof, a large amount of carboxyl groups do not have any affinity for a nozzle plate, in a head for ink jet recording, which has been subjected to water repellency-imparting treatment. Therefore, the ink composition containing the polymer emulsion according to the present invention has an advantage that problems involved in conventional resin-containing ink compositions, that is, an ink droplet trajectory directionality problem and a failure of the ink droplets to be ejected, caused by good wettability of the nozzle plate by the ink composition, can be effectively prevented. Further, the utilization of fine particles of a polymer having a relatively large amount of carboxyl groups can realize better rubbing/scratch resistance and solvent resistance. Further, by virtue of the high level of hydrophilicity of the surface of the fine particles of the polymer, the ink composition can advantageously have excellent storage stability.

According to a preferred embodiment of the present invention, the contact angle of a polymer emulsion, prepared by dispersing the fine particles of a polymer in water to provide a fine particle concentration of 10% by weight, on an ethylene tetrafluoride resin (Teflon: registered trademark) sheet is not less than about 70 degrees, more preferably not less than about 80 degrees. Further, the surface tension of a polymer emulsion, prepared by dispersing the fine particles of a polymer in water to provide a fine particle concentration of 35% by weight is preferably not less than about 40×10⁻³ N/m (40 dynes/cm, 20° C.), more preferably not less than about 50×10⁻³ N/m. The utilization of the above fine particles of the polymer in ink jet recording can more effectively prevent the ink droplet trajectory directionality problem and can realize good prints.

According to another preferred embodiment of the present invention, the fine particles of a polymer contain 1 to 10% by weight of a structure derived from an unsaturated vinyl monomer having a carboxyl group and have a structure crosslinked by a crosslinkable monomer having two or more polymerizable double bonds with the content of the structure derived from the crosslinkable monomer being 0.2 to 4% by weight. The utilization of a three-dimensionally crosslinked polymer prepared by copolymerization of crosslinkable monomers preferably having two or more polymerizable double bonds, more preferably three or more polymerizable double bonds at the time of polymerization, makes it more difficult for the surface of the nozzle plate to be wetted by the ink composition. This can more effectively prevent the ink droplet trajectory directionality problem and, at the same time, can further improve the ejection stability.

According to the present invention, the fine particles of a polymer used may have a single-particle structure. On the other hand, according to the present invention, fine particles of a polymer having a core/shell structure may also be utilized. The core/shell structure comprises a core and a shell surrounding the core. The term “core/shell structure”, used herein refers to “a form such that two or more polymers having different compositions are present in a phase separated state in a particle.” Accordingly, forms of the core/shell structure usable in the present invention include a form wherein the core is entirely covered with the shell, a form wherein the core is partially covered with the shell, and a form wherein a part of the polymer constituting the shell forms a domain or the like within the core particle. Further, the particle may have a multi-layer structure of three or more layers wherein at least one additional layer having a different composition is interposed between the core and the shell.

According to a preferred embodiment of the present invention, the core is formed of a polymer having epoxy groups, and the shell is formed of a polymer having carboxyl groups. The epoxy group is reactive with the carboxyl group. These two groups are allowed to exist separately from each other. That is, the epoxy group and the carboxyl group are present respectively in the core and shell, or vice versa. The reduction in the amount of water or the water-soluble organic solvent causes coalescence of the fine particles of a polymer with one another, and the fine particles of a polymer are deformed by pressure involved in the film formation. As a result, the epoxy groups in the core are bonded to the carboxyl groups in the shell to form a network structure. This can advantageously form a coating having higher strength. The amount of the unsaturated vinyl monomer having an epoxy group is preferably 1 to 10% by weight. According to the present invention, a reaction of a part of the epoxy groups with a part of the carboxyl groups before the film formation is acceptable so far as the film-forming property is not lost. In the present invention, the property such that, when reactive functional groups are allowed to coexist within the fine particles of a polymer, these groups are reacted with each other without the addition of any curing agent at the time of film formation to form a network structure, will be referred to as “self-crosslinkable.”

### Ink Composition

The ink composition according to the present invention is characterized by comprising a pigment, a polymer emulsion, water, and a water-soluble organic solvent, the polymer emulsion having been produced by the above-described production process. The ink composition according to the present invention is used in recording methods using an ink composition. Recording methods using an ink composition include, for example, an ink jet recording method, a recording method using writing utensils, such as pens, and other various printing methods. Preferably, the ink composition according to the present invention is used in an ink jet recording method.

a) Polymer Emulsion

The polymer emulsion is the polymer emulsion which has been produced by the production process according to the present invention. The amount of the polymer emulsion added may be properly determined by the amount of the fine particles of a polymer, constituting the polymer emulsion, based on the ink composition. Thus, the amount of the fine particles of a polymer added is 0.1 to 30% by weight, preferably 5 to 30% by weight, based on the total amount of the ink composition.

b) Pigment

In the ink composition according to the present invention, a pigment is used as the colorant. Pigments are colorants having excellent lightfastness and waterfastness.

Inorganic or organic pigments are usable as the pigment without particular limitation. Examples of inorganic pigments usable herein include, in addition to titanium oxide and iron oxide, carbon blacks produced by known processes, such as contact, furnace, and thermal processes. Examples of organic pigments usable herein include azo pigments (including azo lake, insoluble azo pigment, condensed azo pigment, and chelate azo pigment), polycyclic pigments (for example, phthalocyanine, perylene, perinone, anthraquinone, quinacridone, dioxazine, thioindigo, isoindolinone, and quinophthalone pigments), dye-type chelate pigment (for example, basic dye-type chelate pigments and acid dye type chelate pigment), nitro pigments, nitroso pigments, and aniline black.

Specific examples of carbon blacks include: carbon blacks manufactured by Mitsubishi Chemical Corporation, for example, No. 2300, No. 900, MCF 88, No. 33, No. 40, No. 45, No. 52, MA 7, MA 8, MA 100, and No. 2200 B; carbon blacks manufactured by Columbian Carbon Co., Ltd., for example, Raven 5750, Raven 5250, Raven 5000, Raven 3500, Raven 1255, and Raven 700; carbon blacks manufactured by Cabot Corporation, for example, Regal 400 R, Regal 330 R, Regal 660 R, Mogul L, Mogul 700, Monarch 800, Monarch 880, Monarch 900, Monarch 1000, Monarch 1100, Monarch 1300, and Monarch 1400; and carbon blacks manufactured by Degussa, for example, Color Black FW 1, Color Black FW 2, Color Black FW 2 V, Color Black FW 18, Color Black FW 200, Color Black S 150, Color Black S 160, Color Black S 170, Printex 35, Printex U, Printex V, Printex 140 U, Special Black 6, Special Black 5, Special Black 4A, and Special Black 4.

Pigments usable for yellow inks include C.I. Pigment Yellow 1 (Hanza Yellow), 2, 3 (Hanza Yellow 10 G), 4, 5 (Hanza Yellow 5 G), 6, 7, 10, 11, 12, 13, 14, 16, 17, 24 (Flavanthrone Yellow), 34, 35, 37, 53, 55, 65, 73, 74, 75, 81, 83, 93, 94, 95, 97, 98, 99, 108 (Anthrapyrimidine Yellow), 109, 110, 113, 117, (copper complex salt pigment), 120, 124, 128, 129, 133 (quinophthalone), 138, 139 (isoindolinone), 147, 151, 153 (nickel complex pigment), 154, 167, 172, and 180.

Pigments usable for magenta inks include C.I. Pigment Red 1 (Para Red), 2, 3 (Toluidine Red), 4, 5 (ITR Red), 6, 7, 8, 9, 10, 11, 12, 14, 15, 16, 17, 18, 19, 21, 22, 23, 30, 31, 32, 37, 38 (Pyrazolone Red), 40, 41, 42, 88 (thioindigo), 112 (naphthol AS based-pigment), 114 (naphthol AS based-pigment), 122 (dimethylquinacridone), 123, 144, 146, 149, 150, 166, 168 (Anthoanthrone Orange), 170 (naphthol AS based-pigment), 171, 175, 176, 177, 178, 179 (perylene maroon), 185, 187, 209 (dichloroquinacridone), 219, 224 (perylene based-pigment), and 245 (naphthol AS based-pigment); and C.I. Pigment Violet 19 (quinacridone), 23 (dioxazine violet), 32, 33, 36, 38, 43, and 50.

Pigments usable for cyan inks include C.I. Pigment Blue 15, 15 : 1, 15 : 2, 15 : 3, 16 (metal-free phthalocyanine), 18 (alkali blue toner), 25, 60 (Threne Blue), 65 (violanthrone), and 66 (indigo).

Organic pigments usable for color inks other than magenta, cyan, or yellow ink include C.I. Pigment Green 7 (phthalocyanine green), 10 (green gold), 36, and 37; C.I. Pigment Brown 3, 5, 25, and 26; and C.I. Pigment Orange 1, 2, 5, 7, 13, 14, 15, 16, 24, 34, 36, 38, 40, 43, and 63.

The amount of the pigment added is preferably about 0.1 to 25% by weight, more preferably about 1 to 15% by weight, based on the total amount of the ink composition. The particle diameter of the pigment is preferably not more than 10 μm, more preferably not more than 0.1 μm.

### Surface Treated Pigment

According to one preferred embodiment of the present invention, the pigment used is dispersible in water without the aid of any dispersant. This pigment is such that the pigment has been surface treated so as to attach at least one functional group, selected from the group consisting of carbonyl, carboxyl, hydroxyl, and sulfonic groups or salts of the functional groups, to the surface of the pigment, thereby permitting the pigment to be dispersible in water without any dispersant. More specifically, this surface-modified carbon black may be prepared by grafting a functional group or a molecule containing a functional group onto the surface of carbon black by physical treatment, such as vacuum plasma, or chemical treatment (for example, oxidation with hypochlorous acid, sulfonic acid or the like). In the present invention, a single type or a plurality of types of functional groups may be grafted onto one carbon black particle. The type of the functional group to be grafted and the degree of grafting may be suitably determined by taking the dispersion stability in the ink, the color density, the drying property at the front face of the ink jet head and the like into consideration.

Preferred pigments usable in the present invention may be produced, for example, by a method described in Japanese Patent Laid-Open No. 3498/1996. Carbon black treated by the method described in this publication has a high surface active hydrogen content of 1.5 to 2.5 mmol/g. As a result, the dispersibility of the treated carbon black in water is very high. Commercially available products may also be used as the above pigment, and preferred examples thereof include Microjet CW 1 or Microjet CW 2 manufactured by Orient Chemical Industries, Ltd.

According to a further preferred embodiment of the present invention, the pigment has been treated so that a hydrophilic group is present on the surface thereof. The pigment having a hydrophilic group on its surface may be produced by treating the surface of pigment particles with a hydrophilic group-imparting agent. The pigment constituting the pigment particles having a hydrophilic group on the surface thereof is not particularly limited and may be selected from the above pigment so far as the pigment is not soluble in the hydrophilic group-imparting agent. Preferred are carbon black and organic pigments.

### Sulfonation

Sulfonation refers to a treatment such that a sulfonating agent is utilized as a hydrophilic group-imparting agent to impart a sulfonic group (—SO₂OH) and/or a sulfinic group (—RSO₂H wherein R represents a C₁ to C₁₂ alkyl group or a phenyl group or a derivative thereof) onto the surface of pigment particles.

Suitable sulfonating agents include sulfur-containing treatments. Specific examples of such treatments include sulfuric acid, fuming sulfuric acid, sulfur trioxide, chlorosulfuric acid, fluorosulfuric acid, amidosulfuric acid, sulfonated pyridine, and sulfamic acid. Among them, sulfonating agents, such as sulfur trioxide, sulfonated pyridine, and sulfamic acid, are suitable. They may be used solely or as a mixture of two or more.

Further, sulfur trioxide is usefully utilized in the form of a complex produced by complexing sulfur trioxide with a mixed solvent composed of a solvent, which can form a complex with sulfur trioxide, for example, a basic solvent, such as N,N-dimethylformamide dioxane, pyridine, triethylamine, or trimethylamine, nitromethane, or acetonitrile, with a solvent which will be described later. In particular, the utilization of a complex of sulfur trioxide with a tertiary amine in the surface treatment (in this case, sulfonation) of pigment particles is preferred. The complexed sulfur trioxide can suppress the reaction of sulfur trioxide as an acid. As a result, the surface of the pigment can be treated without causing decomposition or a change in properties of the pigment per se.

When sulfuric acid or fuming sulfuric acid, chlorosulfuric acid, fluorosulfuric acid or the like as such is used as the sulfonating agent, the reaction should be suppressed so that pigment particles are not dissolved. An example of means for suppressing the reaction is to vary the type or the amount of a solvent which will be described later.

The solvent used in the reaction preferably does not react with the sulfonating agent and does not dissolve the pigment, and specific examples thereof include sulfolane, N-methyl-2-pyrrolidone, dimethylacetamide, quinoline, hexamethylphosphoric triamide, chloroform, dichloroethane, tetrachloroethane, tetrachloroethylene, dichloromethane, nitromethane, nitrobenzene, liquid sulfur dioxide, carbon disulfide, and trichlorofluoromethane.

A specific example of a method for sulfonating the surface of the pigment comprises the steps of: dispersing pigment particles in a solvent, adding a sulfur containing treatment to this dispersion, raising the mixture to 60 to 200° C., and stirring the mixture for 3 to 10 hr. More specifically, pigment particles and a solvent are previously sheared at a high speed and dispersed, for example, by a high-speed mixer, or alternatively are impact dispersed, for example, by a beads mill or a jet mill to prepare a slurry (a dispersion). Thereafter, the slurry is mildly stirred, and a sulfur-containing treatment is then added to the slurry to introduce a hydrophilic group into the surface of the pigment particles. Thereafter, heat treatment is carried out to remove the solvent and the residual sulfur-containing treatment from the slurry of the pigment particles. This removal is carried out by the repetition of washing with water, ultrafiltration, reverse osmosis or other method, centrifugation, filtration and the like.

According to a preferred embodiment of the present invention, the sulfonic group and/or the sulfinic group imparted onto the surface of the pigment by the sulfonation are further alkalized with an alkali compound. This treatment can impart a sulfonic acid anion group (—SO₃⁻) and/or a sulfinic acid anion group (—RSO₂ wherein R represents a C₁ to C₁₂ alkyl group or phenyl group or its derivative) as the hydrophilic group to the surface of the pigment.

Alkali compounds include those which, when as such were ionized to form cation, form alkali metal ions or monovalent ions represented by chemical formula R₁R₂R₃R₄N¹ wherein R₁, R₂, R₃, and R₄, which may be the same or different, represent a hydrogen atom, an alkyl group, a hydroxyalkyl group, or an alkyl halide group. Specific examples of preferred alkali compounds include those which, when as such were ionized, form alkanolamine cations, such as lithium ions (Li⁺), potassium ions (K⁺), sodium ions (Na⁺), ammonium ions (NH₄⁺), and triethanolamine cations.

Preferred alkali compounds include those which, when as such ionized to form anion, form hydroxide anions. Specific examples of these alkali compounds include ammonia, alakanolamines (such as monoethanolamine, diethanolamine, N,N-butylethanolamine, triethanolamine, propanolamine, aminomethylpropanol, and 2-aminoisopropanol), and monovalent alkali metal hydroxides (LiOH, NaOH, and KOH).

The amount of the alkali compound added is preferably at least neutralization equivalent of the hydrophilic group which has been imparted by the treatment of the surface of the pigment particles. When the alkali compound is a volatile compound, such as ammonia or an alkanolamine, the addition of the alkali compound is preferably at least 1.5 times the neutralization equivalent of the hydrophilic group.

The alkalization may be carried out by placing the above-described pigment particles, with a hydrophilic group being chemically bonded to the surface thereof, in an alkali compound and then shaking the mixture, for example, in a paint shaker.

### Carboxylation

The carboxylation refers to a treatment such that a carboxylating agent is utilized as a hydrophilic group-imparting agent to impart a carboxylic acid group (—COOH) to the surface of pigment particles. Specific examples of carboxylating agents include sodium hypochlorite and potassium hypochlorite. These treatments cleave a part of bonds on the surface of the pigment particles, for example, C-C or C-C, to oxidize and carboxylate that part.

On the other hand, the present invention embraces, in addition to this chemical treatment, a treatment method wherein a carboxylic acid group is imparted to the surface of the pigment by physical oxidation, such as plasma treatment. In the carboxylation, in some cases, a minor amount of a quinone group or the like is introduced.

A specific example of a method for carboxylating the surface of the pigment is as follows. Pigment particles are previously sheared at a high speed and dispersed in an aqueous medium, for example, by a high-speed mixer, or alternatively are impact dispersed, for example, by a beads mill or a jet mill. Thus, a slurry (a dispersion) is prepared. Thereafter, a suitable amount of sodium hypochlorite (available halogen 10 to 30%) (a carboxylating agent) is mixed into the slurry, and the mixture is then stirred with heating at 60 to 80° C. for about 5 to 10 hr, preferably 10 hr or longer. The solvent and the residual carboxylating agent are then removed from the slurry of the surface treated pigment particles by heat treatment. If necessary, washing with water, ultrafiltration, reverse osmosis or other method, centrifugation, filtration and the like are repeatedly carried out to prepare a desired surface treated pigment.

According to a preferred embodiment of the present invention, the carboxylic acid group, which has been imparted to the surface of the pigment by the carboxylation is further alkalized with an alkali compound. This treatment permits a carboxylic acid anion group (—COO⁻) to be imparted as a hydrophilic group to the surface of the pigment. In this case, the type of the alkali compound and the method for treatment with an alkali compound may be the same as described above.

The average particle diameter of pigment particles having a hydrophilic group on its surface prepared by treating the surface of the pigment may be brought to not more than 150 nm, preferably 20 to 80 nm.

### Dispersant

According to another preferred embodiment of the present invention, the pigment (including the surface treated pigment) is added, to the ink composition, as a pigment dispersion prepared by dispersing the pigment in an aqueous medium with the aid of a dispersant. Specific examples of dispersants usable for the preparation of the pigment dispersion include, for example, polymeric dispersants and surfactants.

Examples of preferred polymeric dispersants include naturally occurring polymeric compounds, and specific examples thereof include: proteins, such as glue, gelatin, casein, and albumin; naturally occurring rubbers, such as gum arabic and tragacanth; glucosides, such as saponin; alginic acid and alginic acid derivatives, such as propylene glycol alginate, triethanolamine alginate, and ammonium alginate; and cellulose derivatives, such as methylcellulose, carboxymethylcellulose, hydroxyethylcellulose, and ethylhydroxycellulose. Examples of additional preferred polymeric dispersants include synthetic polymers, and specific examples thereof include: polyvinyl alcohols; polyvinyl pyrrolidones; acrylic resins, such as polyacrylic acid, acrylic acid/acrylonitrile copolymer, potassium acrylate/acrylonitrile copolymer, vinyl acetate/acrylic ester copolymer, and acrylic acid/acrylic ester copolymer; styrene/acryl resins, such as styrene/acrylic acid copolymer, styrene/methacrylic acid copolymer, styrene/methacrylic acid/acrylic ester copolymer, styrene/a-methylstyrene/acrylic acid copolymer, and styrene/a-methylstyrene/acrylic acid/ acrylic ester copolymer; styrene/maleic acid copolymer; styrene/maleic anhydride copolymer; vinylnaphthalene/acrylic acid copolymer; vinylnaphthalene/maleic acid copolymer; vinyl acetate copolymers, such as vinyl acetate/ethylene copolymer, vinyl acetate/fatty acid vinyl/ethylene copolymer, vinyl acetate/maleic ester copolymer, vinyl acetate/crotonic acid copolymer, and vinyl acetate/acrylic acid copolymer; and salts of the above polymers. Among them, a copolymer of a monomer having a hydrophobic group with a monomer having a hydrophilic group and a polymer of a monomer having both a hydrophobic group and a hydrophilic group in its molecular structure are particularly preferred. Examples of the salt referred to above include salts, for example, with a monovalent inorganic hydroxide, such as lithium hydroxide, sodium hydroxide, or potassium hydroxide, diethylamine, ammonia, ethylamine, triethylamine, propylamine, isopropylamine, dipropylamine, butylamine, isobutylamine, triethanolamine, diethanolamine, aminomethyl propanol, or morpholine. For these copolymers, the weight average molecular weight is preferably 3,000 to 30,000, more preferably 5,000 to 15,000.

Specific examples of preferred surfactants as the dispersant include anionic surfactants typified, for example, by sulfonic acid-type surfactants, such as salts of alkanesulfonic acids, salts of α-olefinsulfonic acids (AOS), salts of alkylbenzenesulfonic acids (ABS), salts of alkylnaphthalenesulfonic acids, acylmethyl tauride, and salts of dialkylsulfosuccinic acids; sulfuric ester-type surfactants, such as alkylsulfuric acid ether salts, sulfated oils, sulfated olefins, polyoxyethylene alkyl ether sulfates, and polyoxyethylene alkylphenyl ether sulfates; carboxylic acid-type surfactants, such as fatty acid salts (soap) and alkylsarcosine salts; phosphoric ester-type surfactants, such as alkyl phosphates, polyoxyethylene alkyl ether phosphates, polyoxyethylene alkylphenyl ether phosphates, and monoglyceride phosphates. Specific examples of preferred additional surfactants include amphoteric surfactants typified, for example, by pyridinium-type surfactants, such as alkylpyridinium salts; amino acid-type surfactants, such as alkylamino acids salts; and betaine-type surfactants, such as alkyldimethylbetaine. Specific examples of preferred additional surfactants include nonionic surfactants typified, for example, by ethylene oxide addition-type surfactants, such as polyoxyethylene alkyl ethers, polyoxyethylene alkylphenyl ethers, polyoxyethylene alkyl esters, and polyoxyethylene alkylamides; polyol ester-type surfactants, such as glycerin alkyl esters, sorbitan alkyl esters, and sugar alkyl esters; polyol ether-type surfactants, such as polyhydric alcohol alkyl ethers; and alkanolamide-type surfactants, such as alkanolamine fatty acid amides.

The amount of these dispersants added is preferably in the range of 1 to 50% by weight, more preferably in the range of 5 to 30% by weight, based on the pigment.

c) Water-soluble Organic Solvent

The ink composition according to the present invention is composed mainly of water and a water-soluble organic solvent.

According to a preferred embodiment of the present invention, the ink composition used in the present invention further comprises a wetting agent comprising a high-boiling organic solvent as the water-soluble organic solvent. Examples of preferred high-boiling organic solvents include: polyhydric alcohols, such as ethylene glycol, diethylene glycol, triethylene glycol, polyethylene glycol, polypropylene glycol, propylene glycol, butylene glycol, 1,2,6-hexanetriol, thioglycol, hexylene glycol, glycerin, trimethylolethane, and trimethylolpropane; alkyl ethers of polyhydric alcohols, such as ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether; 2-pyrrolidone and N-methyl-2-pyrrolidone; 1,3-dimethyl-2-imidazolidinone; and triethanolamine.

Among them, the utilization of water-soluble organic solvents having a boiling point of 180° C. or above is preferred. The use of water-soluble organic solvents having a boiling point of 180° C. or above can impart water retention and wetting properties to the ink composition. As a result, storage of the ink composition for a long period of time neither causes coagulation of pigment nor an increase in the viscosity of the ink composition. Thus, excellent storage stability can be realized. Further, an ink composition can be realized which, even when allowed to stand in an open state, that is, when allowed to stand in contact with air at room temperature, can maintain the fluidity and the redispersibility for a long period of time, and, in addition, when used in ink jet recording, does not cause clogging of nozzles during printing or at the time of restarting after interruption of printing, thus offering high ejection stability.

Examples of water-soluble organic solvents having a boiling point of 180° C. or above include ethylene glycol (b.p.: 197° C.; the boiling point being hereinafter described within parentheses), propylene glycol (187° C.), diethylene glycol (245° C.), pentamethylene glycol (242° C.), trimethylene glycol (214° C.), 2-butene-1,4-diol (235° C.), 2-ethyl-1,3-hexanediol (243° C.), 2-methyl-2,4-pentanediol (197° C.), N-methyl-2-pyrrolidone (202° C.), 1,3-dimethyl-2-imidazolidinone (257-260° C.), glycerin (290° C.), tripropylene glycol monomethyl ether (243° C.), dipropylene glycol monoethyl glycol (198° C.), dipropylene glycol monomethyl ether (190° C.), dipropylene glycol (232° C.), triethylene glycol monomethyl ether (249° C.), tetraethylene glycol (327° C.), triethylene glycol (288° C.), diethylene glycol monobutyl ether (230° C.), diethylene glycol monoethyl ether (202° C.), and diethylene glycol monomethyl ether (194° C.). Among these water-soluble organic solvents, those having a boiling point of 200° C. or above are preferred. These water-soluble organic solvents may be used solely or as a mixture of two or more.

The amount of these high-boiling organic solvents added is preferably 0.01 to 50% by weight, more preferably 0.1 to 40% by weight, based on the total amount of the ink composition.

The ink composition according to the present invention may contain a low-boiling organic solvent, and specific examples of preferred low-boiling organic solvents include methanol, ethanol, n-propyl alcohol, iso-propyl alcohol, n-butanol, sec-butanol, tert-butanol, iso-butanol, and n-pentanol. Monohydric alcohols are particularly preferred low-boiling organic solvents. The amount of these low-boiling organic solvents added is preferably in the range of 0.5 to 10% by weight, more preferably in the range of 0.5 to 6% by weight, based on the ink composition.

d) Penetrating Agent or Wetting Agent

### Penetrating Agent

According to a preferred embodiment of the present invention, the ink composition may further comprise a penetrating agent. Some of the above-described water-soluble organic solvents can function as a penetrating agent. According to the present invention, the following compounds are preferably utilized as the penetrating agent.

Specific examples of preferred penetrating agents include 1,2-alkyl diols, glycol ethers, acetylene glycol surfactants, and acetylene alcohol surfactants. They may be used solely or as a mixture of two or more.

Specific examples of preferred 1,2-alkyl diols include 1,2-hexanediol and 1,2-pentanediol.

Specific examples of glycol ethers include dialkylene glycol monobutyl ethers, dialkylene glycol monopentyl ethers, dialkylene glycol monohexyl ethers, trialkylene glycol monobutyl ethers, trialkylene glycol monopentyl ethers, trialkylene glycol monohexyl ethers, tetraalkylene glycol monobutyl ethers, tetraalkylene glycol monopentyl ethers, and tetraalkylene glycol monohexyl ethers. Specific examples of preferred glycol ethers include diethylene glycol monobutyl ether, diethylene glycol monopentyl ether, diethylene glycol monohexyl ether, triethylene glycol monobutyl ether, triethylene glycol monohexyl ether, triethylene glycol monopentyl ether, tetraethylene glycol monobutyl ether, tetraethylene glycol monopentyl ether, and tetraethylene glycol monohexyl ether.

The amount of the 1,2-alkylene glycol or the glycol ether added is preferably 1 to 20% by weight, more preferably 1 to 10% by weight, based on the total weight of the ink composition.

The addition of the acetylene glycol surfactant and the acetylene alcohol surfactant can enhance the ability of the ink composition to penetrate recording media, and thus can be expected to realize the formation of prints having no significant feathering or bleeding on various recording media. Specific examples of acetylene glycol surfactants and acetylene alcohol surfactants include compounds represented by formula (I):

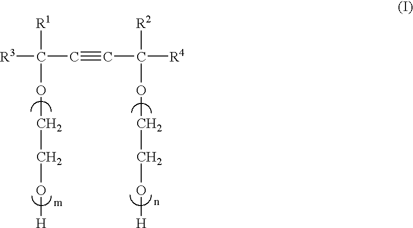

wherein

0≦m+n≦50; and

R¹, R², R³, and R⁴ each independently represent an alkyl group, preferably an alkyl group having 6 or less carbon atoms.

Among the compounds represented by formula (I), particularly preferred compounds include 2,4,7,9-tetramethyl-5-decyne-4,7-diol, 3,6-dimethyl-4-octyne-3,6-diol, and 3,5-dimethyl-1-hexyn-3-ol. Commercially available products may also be used as the acetylene glycol surfactants represented by formula (I). Specific examples thereof include Surfynol 104, Surfynol 82, Surfynol 465, Surfynol 485, and Surfynol TG (all the above products being available from Air Products and Chemicals Inc.) and OLFINE STG and OLFINE E 1010 (tradenames: manufactured by Nissin Chemical Industry Co., Ltd.). The amount of the acetylene glycol surfactant and the acetylene alcohol surfactant added is preferably about 0.01 to 10% by weight, more preferably about 0.1 to 5.0% by weight, still more preferably about 0.5 to 2.0% by weight, based on the total amount of the ink composition.

According to the present invention, other surfactants may be utilized as the penetrating agent. Specific examples of such surfactants include: anionic surfactants, for example, sodium dodecylbenzenesulfonate, sodium laurate, ammonium or other salts of polyoxyethylene alkyl ether sulfates; nonionic surfactants, for example, polyoxyethylene alkyl ethers, polyoxyethylene alkyl esters, polyoxyethylene sorbitan fatty acid esters, polyoxyethylene alkylphenyl ethers, polyoxyethylene alkylamines, polyoxyethylene alkylamides; amphoteric surfactants, for example, N,N-dimethyl-N-alkyl-N-carboxymethyl ammonium betaine, N,N-dialkylaminoalkylenecarboxylic acid salts, N,N,N-trialkyl-N-sulfoalkylene ammonium betaine, N,N-dialkyl-N,N-bispolyoxyethylene ammonium sulfate betaine, and 2-alkyl-1-carboxymethyl-1-hydroxyethylimidazolinium betaine. They may be used solely or in a combination of two or more.

The amount of these surfactants added is in the range of 0.01 to 10% by weight, preferably in the range of 0.1 to 5% by weight, based on the ink composition.

### Wetting Agent

According to a preferred embodiment of the present invention, the ink composition further comprises a wetting agent. Some of the above water-soluble organic solvents can function as a wetting agent. According to the present invention, the following compounds are preferably utilized as the wetting agent.

According to the present invention, the wetting agent is preferably a water-soluble organic solvent which has a boiling point of 180° C. or above and can absorb and retain water. In the present invention, particularly preferred wetting agents are glycerin (b.p.: 290° C.) and trimethylene glycol (b.p.: 210° C.). The amount of the wetting agent added is preferably in the range of 5 to 30% by weight, more preferably in the range of 10 to 20% by weight, based on the total weight of the ink composition for ink jet recording.

According to the present invention, tertiary amines may also be utilized as the wetting agent. Examples of tertiary amines include trimethylamine, triethylamine, triethanolamine, dimethylethanolamine, diethylethanolamine, triisopropenolamine, and butyldiethanolamine. They may be used solely or as a mixture of two or more. The amount of these tertiary amines added is preferably about 0.1 to 10% by weight, more preferably about 0.5 to 5% by weight, based on the total amount of the ink composition.

According to another preferred embodiment of the present invention, the ink composition further comprises a solid wetting agent. In the present invention, the solid wetting agent refers to a water-soluble compound which can retain water and is solid at room temperature (25° C.). In the present invention, specific examples of particularly preferred wetting agents include saccharides, sugar alcohols, salts of hyaluronic acid, trimethylolpropane, and 1,2,6-hexanetriol. Examples of saccharides include monosaccharides, disaccharides, oligosaccharides (including trisaccharides and tetrasaccharides), and polysaccharides, and preferred examples thereof include glucose, mannose, fructose, ribose, xylose, arabinose, galactose, aldonic acid, glucitol, sorbit, maltose, cellobiose, lactose, sucrose, trehalose, and maltotriose. The polysaccharides refer to saccharides in a wide sense and embrace materials which widely exist in the natural world, such as alginic acid, α-cyclodextrin, and cellulose. Derivatives of these saccharides include reducing sugars of the above saccharides (for example, sugar alcohols represented by the general formula HOCH₂(CHOH)ₙ CH₂OH wherein n is an integer of 2 to 5), oxidized sugars (for example, aldonic acid and uronic acid), amino acid, and thiosugars. Sugar alcohols are particularly preferred, and specific examples thereof include maltitol, sorbitol, and xylitol. The salt of hyaluronic acid may be 1% aqueous solution of sodium hyaluronate (molecular weight 350000) which is commercially available. These solid wetting agents may be used solely or as a mixture of two or more. When the solid wetting agents are used as a mixture of two or more, preferred is a combination of two or more members selected from the group consisting of saccharides, sugar alcohols, salts of hyaluronic acid, trimethylolpropane, and 1,2,6-hexanetriol.

The amount of the solid wetting agent added is preferably 3 to 20% by weight, more preferably 3 to 10% by weight, based on the total weight of the ink composition.

e) pH Adjustor

The ink composition according to the present invention may further comprise a pH adjustor. The pH adjustor is added for stably maintaining properties of the ink composition, such as viscosity. Specific examples of preferred pH adjustors include monovalent inorganic hydroxides. More preferred are hydroxides of alkyl metals. Among others, potassium hydroxide, sodium hydroxide, and lithium hydroxide are preferred. The amount of the pH adjustor added may be properly determined so that the ink composition has a pH value in the range of 7.5 to 8.5.

f) Other Ingredients

If necessary, the ink composition according to the present invention may further comprise preservatives, fungicides, antioxidants, surface tension modifiers, nozzle clogging preventives or other additives. The preservative or fungicide may be selected, for example, from sodium benzoate, pentachlorophenol sodium, 2-pyridinethiol-1-oxide sodium, sodium sorbate, sodium dehydroacetate, and 1,2-dibenzothiazolin-3-one (Proxel CRL, Proxel BDN, Proxel GXL, Proxel XL-2, and Proxel TN, manufactured by ICI).

### Production of Ink Composition

The ink composition according to the present invention may be prepared by dispersing and mixing the above ingredients together by means of a suitable method. A pigment dispersion containing a homogeneously dispersed pigment is prepared by means of a proper dispergator, for example, a ball mill, a sand mill, an attritor, a roll mill, an agitator mill, a Henschel mixer, a colloid mill, an ultrasonic homogenizer, a jet mill, or an angmill. Subsequently, a polymer emulsion, a water-soluble organic solvent, a penetrating agent, a wetting agent, a pH adjustor, a preservative, a fungicide and the like are added to the dispersion, followed by thorough stirring to prepare an ink solution. After thorough stirring, the ink solution is filtered or centrifuged to remove coarse particles and foreign matter causative of nozzle clogging to prepare a contemplated ink composition.

### Recording Medium

Recording media, which are absorptive to an ink composition, such as paper, or recording media having an ink-receptive layer are suitably used in the present invention. When the step of heating is provided after printing, recording media, which are substantially non-absorptive to the ink composition, may also be used. Specific examples of recording media include: recording papers, such as plain papers, recycled papers, wood-free papers, and specialty papers for ink jet recording; plastic sheets using, as a substrate, for example, polyethylene terephthalate, polycarbonate, polypropylene, polyethylene, polysulfone, ABS resin, or polyvinyl chloride; metal-coated recording media prepared by depositing a metal onto the surface of metals, such as brass, iron, aluminum, SUS, or copper, or nonmetallic substrates, for example, by vapor deposition; recording media formed, for example, by subjecting the surface of paper as a substrate to water repellency-imparting treatment; recording media formed, for example, by subjecting the surface of fibers, such as cloths, to water repellency-imparting treatment; and recording media formed of the so-called “ceramic material,” formed by baking an inorganic material at a high temperature.

### EXAMPLES

The present invention will be described with reference to the following examples, though it is not limited to these examples only.

### Preparation of Polymer Emulsions: A

Polymer emulsions comprising fine particles of a polymer as dispersed particles were prepared by the following method. Various properties of the polymer emulsions thus obtained were measured by the following methods.

### Preparation

Potassium persulfate (0.5 part by weight) and 80 parts by weight of pure water were added under a nitrogen atmosphere to a flask equipped with a stirrer, a thermometer, a reflux condenser, and a dropping funnel. The contents of the flask were dissolved, and the internal temperature of the flask was raised to 70° C. with stirring. On the other hand, ingredients indicated in Tables A1 and A2 (numeric numbers in Tables A1 and A2 being in parts by weight) below were mixed and stirred to prepare an emulsification product. The emulsification product was gradually added dropwise to the flask through the dropping funnel over a period of 3 hr to perform an emulsion polymerization reaction. KOH, NaOH, and LiOH (example of the invention) were added to portions of the resultant polymer emulsion, while ammonia (comparative example) was added to the remaining portion of the polymer emulsion, whereby the portions of the polymer emulsion were adjusted to a solid content of 40% by weight and to pH 8 to prepare polymer emulsions. The polymer emulsions thus obtained had a minimum film-forming temperature of about 20° C. and an average particle diameter of 150 nm.

### Measurement of Minimum Film-forming Temperature: A

The minimum film-forming temperature was measured with a minimum film-forming temperature measuring device. As soon as the temperature gradient on an aluminum sample plate has reached equilibrium, the polymer emulsion was thinly spread followed by drying. When the surface of the sample plate is observed after the completion of drying, a transparent, continuous film is formed in a temperature range of the minimum film-forming temperature or above, while a white powder is formed in a temperature range below the minimum film-forming temperature. The temperature of the boundary between the temperature, at which the transparent continuous film was formed, and the temperature, at which the white powder was formed, was measured and regarded as the minimum film-forming temperature.

### Measurement of Contact Angle: A

The contact angle was measured with a contact angle measuring device at 25° C. One drop of a polymer emulsion, which had been prepared so as to have a content of fine particles of a polymer of 10% by weight, was dropped on an ethylene tetrafluoride resin (Teflon; trademark) plate having a smooth surface, and the contact angle at that time was read under a microscope.

### Measurement of Surface Tension: A

A polymer emulsion, which had been prepared so as to have a content of fine particles of a polymer of 35% by weight, was measured for the surface tension at 25° C. with a full automatic balanced electro-surface tension digiomatic model ESB-IV manufactured by Kyowa Scientific Co., Ltd.

### Measurement of Half-value Period in Reaction with Divalent Metal Ions: A

A polymer emulsion (3 ml), which had been prepared so as to have a content of fine particles of a polymer of 0.1% by weight, was placed in a cell for a spectrophotometer with caution so as to avoid the entry of air bubbles, followed by setting in a sample chamber of the spectrophotometer. At the same time that 1 ml of a 1 mol/liter aqueous magnesium chloride solution was added dropwise to the cell, a change in transmittance at a wavelength of 700 nm with the elapse of time was measured to determine the time required for the transmittance to become 50% of the initial transmittance value.

### Measurement of Average Particle Diameter: A

The average particle diameter was measured with a laser doppler-type particle size distribution measuring device Microtrack UPA 150 manufactured by Leeds & Northrup.

### Preparation of Ink Composition: A

Ink compositions were prepared using ingredients indicated in Tables A3 to A6 (numeric values in Tables A3 to A6 being in % by weight) below according to the following procedure. At the outset, the pigment, the dispersant, and water were mixed together, and the mixture was dispersed in a sand mill for 2 hr (manufactured by Yasukawa Seisakusho; filler: zirconia (diameter 1 mm, filling ratio 60%)). Thereafter, coarse particles were removed by a centrifuge to prepare an aqueous dispersion of a pigment. Separately, the polymer emulsion and the remaining ingredients were mixed, followed by stirring at room temperature for 20 min to prepare a stirred product. The aqueous dispersion of a pigment prepared above was gradually added dropwise to the stirred product, and the mixture was stirred for additional 20 min, and the mixture was then filtered through a 5μm membrane filter to prepare an ink composition.

### Evaluation Test A

### Evaluation Test of Polymer Emulsions: A

The polymer emulsion (50 ml) prepared above was placed in a polypropylene vessel at room temperature (about 20° C.). Thereafter, the vessel was allowed to stand at 60° C. for 4 weeks, and the polymer emulsion was measured for pH and viscosity which were then evaluated according to the following criteria. The results were as summarized in Tables A1 or A2 below. In Tables A1 and A2, MFT represents the minimum film-forming temperature of the polymer emulsion, and γ represents the surface tension.

A: As compared with the initial values, neither pH nor viscosity changed.

B: As compared with the initial values, pH lowered by 10%, and the viscosity increased by 10%.

C: As compared with the initial values, pH lowered by not less than 20%, and the viscosity increased by not less than 20%.

### Evaluation Test of Ink Compositions: A

For the above ink compositions, the following ink evaluation tests were carried out. In this connection, in evaluations A2 and A3, printing was carried out as follows. Characters were printed on the following papers by means of an ink jet printer MJ-700 C manufactured by Seiko Epson Corporation. The amount of ink ejected was 0.07 μg/dot, and the density was 360 dpi. The papers used in the printing tests were as follows. The results of evaluation for the individual evaluation items were as summarized in Tables A3 to A6 below.

Xerox P, manufactured by Xerox Corp.

Xerox 4024, manufactured by Xerox Corp.

Xerox R (recycled paper), manufactured by Xerox Corp.

Yamayuri (recycled paper), manufactured by Honshu Paper Co., Ltd.

### Evaluation A1: Storage Stability

The ink composition (50 ml) prepared above was placed in a polypropylene vessel at room temperature (about 20° C.). Thereafter, the vessel was allowed to stand at 60° C. for 4 weeks, and the polymer emulsion was measured for pH and viscosity which were then evaluated according to the following criteria.

A: As compared with the initial values, neither pH nor viscosity changed.

B: As compared with the initial values, pH lowered by 10%, and the viscosity increased by 10%.

C: As compared with the initial values, pH lowered by not less than 20%, and the viscosity increased by not less than 20%.

### Evaluation A2: Anti-clogging Property

The ink composition was loaded into the printer, and alphameric characters were continuously printed for 10 min. Thereafter, the printer was stopped, and was allowed to stand for one week without capping under an environment of temperature 40° C. and humidity 25%. After the standing, alphameric characters were printed again to determine the number of cleaning operations necessary for print quality equal to that before the standing to be obtained. The results were evaluated according to the following criteria.

A: Print quality equal to the initial print quality could be obtained after 0 to 2 cleaning operations.

B: Print quality equal to the initial print quality could be obtained after 3 to 5 cleaning operations.

C: Print quality equal to the initial print quality could not be obtained even after 6 or more cleaning operations.

### Evaluation A3: Ejection Stability

The ink composition was loaded into the printer, and alphameric characters were continuously printed. At that time, inspection was performed on dropouts of dots and scattering of ink. In this case, the number of sheets of the recording paper required for dropouts of dots and scattering of ink to occur was counted. The results were evaluated according to the following criteria.

A: Less than 1,000 sheets

B: 1,000 to 5,000 sheets

C: More than 5,000 sheets

TABLE A1

| Single particle structure | | Ex. A1 | Ex. A2 | Ex. A3 | Comp.Ex. A1 | Ex. A4 | Ex. A5 | Ex. A6 | Comp.Ex. A2 |
|---|---|---|---|---|---|---|---|---|---|
| Acrylamide | | 20 | 20 | 20 | 20 | 20 | 20 | 20 | 20 |
| Styrene | | 435 | 435 | 435 | 435 | 435 | 435 | 435 | 435 |
| Butyl acrylate | | 475 | 475 | 475 | 475 | 475 | 475 | 475 | 475 |
| Methacrylic acid | | 30 | 30 | 30 | 30 | 30 | 30 | 30 | 30 |
| Ethylene glycol | | — | — | — | — | 2 | 2 | 2 | 2 |
| dimethacrylate | | | | | | | | | |
| Neutralizing | Ammonia | | | | ◯ | | | | ◯ |
| agent | KOH | ◯ | | | | ◯ | | | |
| | NaOH | | ◯ | | | | ◯ | | |
| | LiOH | | | ◯ | | | | ◯ | |

| | | | | | | | | |
|---|---|---|---|---|---|---|---|---|
| MFT, °C. | 22 | 22 | 22 | 22 | 22 | 22 | 22 | 22 |
| γ, mN/m | 67 | 67 | 57 | 57 | 58 | 58 | 58 | 59 |
| Contact angle, ° | 88 | 89 | 89 | 89 | 113 | 113 | 113 | 113 |
| Average particle diameter, | 0.08 | 0.08 | 0.08 | 0.08 | 0.08 | 0.08 | 0.08 | 0.08 |
| μm | | | | | | | | |
| Half-value period in | 70 | 70 | 70 | 70 | 5 | 5 | 5 | 5 |
| reaction with Mg ion, sec | | | | | | | | |
| Evaluation test on polymer | A | A | A | B | A | A | A | B |
| emulsions | | | | | | | | |

TABLE A2

| | | | | | Comp. | | | | Comp. | | Comp. |
|---|---|---|---|---|---|---|---|---|---|---|---|
| Core-shell structure | | Ex.A7 | Ex.A8 | Ex.A9 | Ex.A3 | Ex.A10 | Ex.A11 | Ex.A12 | Ex.A2 | Ex.A13 | Ex.A5 |
| Styrene | | 53 | 53 | 53 | 53 | 53 | 53 | 53 | 53 | 53 | 53 |
| Butyl acrylate | | 58 | 59 | 59 | 59 | 59 | 59 | 59 | 59 | 59 | 59 |
| Glycidyl methacrylate | | 48 | 48 | 48 | 48 | 48 | 48 | 48 | 48 | 48 | 48 |
| Acrylamide | | 1 | 1 | 1 | 1 | 1 | 1 | 1 | 1 | 1 | 1 |
| Styrene | | 79 | 79 | 79 | 79 | 79 | 79 | 79 | 79 | 79 | 79 |
| Butyl acrylate | | 80 | 80 | 80 | 80 | 80 | 80 | 80 | 80 | 80 | 80 |
| Acrylamide | | 18 | 16 | 16 | 16 | 16 | 16 | 16 | 16 | 16 | 16 |
| Styrene | | 296 | 298 | 298 | 298 | 298 | 298 | 298 | 298 | 298 | 288 |
| Butyl acrylate | | 287 | 297 | 287 | 297 | 287 | 297 | 297 | 287 | 297 | 287 |
| Methacrylic acid | | 29 | 29 | 29 | 29 | 29 | 29 | 29 | 29 | 29 | 28 |
| Ethylene glycol dimethacrylate | | — | — | — | — | 10 | 10 | 10 | 10 | 10 | 10 |
| Neutralizing agent | Ammonia | | | | ◯ | | | | ◯ | | ◯ |
| | KOH | ◯ | | | | ◯ | | | | ◯ | |
| | NaOH | | ◯ | | | | ◯ | | | | |
| | LiOH | | | ◯ | | | | ◯ | | | |

| | | | | | | | | | | |
|---|---|---|---|---|---|---|---|---|---|---|
| MFT, °C. | 24 | 24 | 24 | 24 | 24 | 24 | 24 | 24 | 24 | 24 |
| γ, mN/m | 57 | 57 | 57 | 57 | 58 | 58 | 58 | 58 | 55 | 55 |
| Contact angle, ° | 90 | 90 | 90 | 90 | 108 | 108 | 108 | 108 | 82 | 92 |
| Average particle diameter, μm | 0.09 | 0.09 | 0.09 | 0.09 | 0.09 | 0.09 | 0.09 | 0.09 | 0.18 | 0.18 |
| Half-value period in reaction | 80 | 80 | 80 | 80 | 10 | 10 | 10 | 10 | 3620 | 3620 |
| with Mg ion, sec | | | | | | | | | | |
| Evaluation test on polymer | A | A | A | B | A | A | A | B | A | B |
| emulsions | | | | | | | | | | |

TABLE A3

| | | | Ink A1 | Ink A2 | Ink A3 | Ink A4 | Ink A5 | Ink A6 | Ink A7 | Ink A8 | Ink A9 | Ink A10 |
|---|---|---|---|---|---|---|---|---|---|---|---|---|
| Carbon black MA 7 | | | 5 | 5 | 5 | 5 | 5 | 5 | 5 | 5 | 5 | 5 |
| Dispersant* | | | 1 | 1 | 1 | 1 | 1 | 1 | 1 | 1 | 1 | 1 |
| Polymer emulsion | | | Ex. A1 | Ex. A1 | Ex. A2 | Ex. A2 | Ex. A3 | Ex. A3 | Ex. A4 | Ex. A4 | Ex. A5 | Ex. A6 |
| Glycerin | | | 15 | 15 | 15 | 15 | 15 | 15 | 15 | 15 | 15 | 15 |
| Maltitol | | | — | 7 | — | 7 | — | 7 | — | 7 | — | 7 |
| KOH | | | 1 | 1 | | | | | 1 | 1 | | |
| NaOH | | | | | 1 | 1 | | | | | 1 | 1 |
| LiOH | | | | | | | 1 | 1 | | | | |
| Water | | | Balance | Balance | Balance | Balance | Balance | Balance | Balance | Balance | Balance | Balance |
| Evalu- | 1 | (Storage | A | A | A | A | A | A | A | A | A | A |
| ation | | stability) | | | | | | | | | | |
| | 2 | (Anti-clogging | A | A | A | A | A | A | A | A | A | A |
| | | property) | | | | | | | | | | |
| | 3 | (Ejection | A | A | A | A | A | A | A | A | A | A |
| | | stability) | | | | | | | | | | |

Dispersant*: Sodium salt of styrene-acrylic acid copolymer (weight average molecular weight 5,000, acid value 200, tradename Joncryl 555, manufactured by Johnson Polymer Corp.

TABLE A4

| | | | Ink A11 | Ink A12 | Ink A13 | Ink A14 | Ink A15 | Ink A16 | Ink A17 | Ink A18 | Ink A19 | Ink A20 |
|---|---|---|---|---|---|---|---|---|---|---|---|---|
| Carbon black MA 7 | | | 5 | 5 | 5 | 5 | 5 | 5 | 5 | 5 | 5 | 5 |
| Dispersant* | | | 1 | 1 | 1 | 1 | 1 | 1 | 1 | 1 | 1 | 1 |
| Polymer emulsion | | | Ex. A6 | Ex. A6 | Ex. A7 | Ex. A7 | Ex. A8 | Ex. A8 | Ex. A9 | Ex. A9 | Ex. A10 | Ex. A10 |
| Glycerin | | | 15 | 15 | 15 | 15 | 15 | 15 | 15 | 15 | 15 | 15 |
| Maltitol | | | — | 7 | — | 7 | — | 7 | — | 7 | — | 7 |
| KOH | | | | | 1 | 1 | | | | | 1 | 1 |
| NaOH | | | | | | | 1 | 1 | | | | |
| LiOH | | | 1 | 1 | | | | | 1 | 1 | | |
| Water | | | Balance | Balance | Balance | Balance | Balance | Balance | Balance | Balance | Balance | Balance |
| Evalu- | 1 | (Storage | A | A | A | A | A | A | A | A | A | A |
| ation | | stability) | | | | | | | | | | |
| | 2 | (Anti-clogging | A | A | A | A | A | A | A | A | A | A |
| | | property) | | | | | | | | | | |
| | 3 | (Ejection | A | A | A | A | A | A | A | A | A | A |
| | | stability) | | | | | | | | | | |

Dispersant*: Sodium salt of styrene-acrylic acid copolymer (weight average molecular weight 5,000, acid value 200, tradename Joncryl 555, manufactured by Johnson Polymer Corp.)

TABLE A5

| | | | Ink A21 | Ink A22 | Ink A23 | Ink A24 | Ink A25 | Ink A26 |
|---|---|---|---|---|---|---|---|---|
| Carbon black MA 7 | | | 5 | 5 | 5 | 5 | 5 | 5 |
| Dispersant* | | | 1 | 1 | 1 | 1 | 1 | 1 |
| Polymer emulsion | | | Ex. A11 | Ex. A11 | Ex. A12 | Ex. A12 | Ex. A13 | Ex. A13 |
| Glycerin | | | 15 | 15 | 15 | 15 | 15 | 15 |
| Maltitol | | | — | 7 | — | 7 | — | 7 |
| KOH | | | | | | | 1 | 1 |
| NaOH | | | 1 | 1 | | | | |
| LiOH | | | | | 1 | 1 | | |
| Water | | | Balance | Balance | Balance | Balance | Balance | Balance |
| Evalu- | 1 | (Storage | A | A | A | A | A | A |
| ation | | stability) | | | | | | |
| | 2 | (Anti-clogging | A | A | A | A | A | A |
| | | property) | | | | | | |
| | 3 | (Ejection | A | A | A | A | A | A |
| | | stability) | | | | | | |

Dispersant*: Sodium salt of styrene-acrylic acid copolymer (weight average molecular weight 5,000, acid value 200, tradename Joncryl 555, manufactured by Johnson Polymer Corp.)

TABLE A6

| | | | Ink A27 | Ink A28 | Ink A29 | Ink A30 | Ink A31 | Ink A32 | Ink A33 | Ink A34 | Ink A35 | Ink A36 |
|---|---|---|---|---|---|---|---|---|---|---|---|---|
| Carbon black MA 7 | | | 5 | 5 | 5 | 5 | 5 | 5 | 5 | 5 | 5 | 5 |
| Dispersant* | | | 1 | 1 | 1 | 1 | 1 | 1 | 1 | 1 | 1 | 1 |
| Polymer emulsion | | | Comp. | Comp. | Comp. | Comp. | Comp. | Comp. | Comp. | Comp. | Comp. | Comp. |
| | | | Ex. 1 | Ex. 1 | Ex. 2 | Ex. 2 | Ex. 3 | Ex. 3 | Ex. 4 | Ex. 4 | Ex. 5 | Ex. 5 |
| Glycerin | | | 15 | 15 | 15 | 15 | 15 | 15 | 15 | 15 | 15 | 15 |
| Maltitol | | | — | 7 | — | 7 | — | 7 | — | 7 | — | 7 |
| Triethanolamine | | | 1 | 1 | 1 | 1 | 1 | 1 | 1 | 1 | 1 | 1 |
| Water | | | Balance | Balance | Balance | Balance | Balance | Balance | Balance | Balance | Balance | Balance |
| Evalu- | 1 | (Storage | B | B | B | B | B | B | B | B | B | B |
| ation | | stability) | | | | | | | | | | |
| | 2 | (Anti-clogging | B | B | B | B | B | B | B | B | B | B |
| | | property) | | | | | | | | | | |
| | 3 | (Ejection | B | B | B | B | B | B | B | B | B | B |
| | | stability) | | | | | | | | | | |

Dispersant*: Sodium salt of styrene-acrylic acid copolymer (weight average molecular weight 5,000, acid value 200, tradename Joncryl 555, manufactured by Johnson Polymer Corp.)

### Preparation of Polymer Emulsion: B

Aqueous emulsions comprising fine particles of a polymer as dispersed particles were prepared by the following method. Properties of the aqueous emulsions thus obtained were measured by the following methods.

### Measurement of Minimum Film-forming Temperature: B

The minimum film-forming temperature was measured with a minimum film-forming temperature measuring device. As soon as the temperature gradient on an aluminum sample plate has reached equilibrium, the aqueous emulsion was thinly spread followed by drying. When the surface of the sample plate is observed after the completion of drying, a transparent, continuous film is formed in a temperature range of the minimum film-forming temperature or above, while a white powder is formed in a temperature range below the minimum film-forming temperature. The temperature of the boundary between the temperature, at which the transparent continuous film was formed, and the temperature, at which the white powder was formed, was measured and regarded as the minimum film-forming temperature.

### Measurement of Contact Angle: B

The contact angle was measured with a contact angle measuring device at 25° C. One drop of an aqueous emulsion, which had been prepared so as to have a concentration of 10% by weight, was dropped on an ethylene tetrafluoride resin (Teflon; trademark) plate having a smooth surface, and the contact angle at that time was read under a microscope.

### Measurement of Surface Tension: B

An aqueous emulsion, which had been prepared so as to have a solid content of 35% by weight, was measured for the surface tension at 25° C. with a full automatic balanced electro-surface tension digiomatic model ESB-IV manufactured by Kyowa Scientific Co., Ltd.

### Measurement of Half-value Period in Reaction with Divalent Metal Ions: B

An aqueous emulsion (3 ml), which had been prepared so as to have a content of fine particles of a polymer of 0.1% by weight, was placed in a cell for a spectrophotometer with caution so as to avoid the entry of air bubbles, followed by setting in a sample chamber of the spectrophotometer. At the same time that 1 ml of a 1 mol/liter aqueous magnesium chloride solution was added dropwise to the cell, a change in transmittance at a wavelength of 700 nm with the elapse of time was measured to determine the time required for the transmittance to become 50% of the initial transmittance.

### Measurement of Average Particle Diameter: B

The average particle diameter was measured with a laser doppler-type particle size distribution measuring device Microtrack UPA 150 manufactured by Leeds & Northrup.

### Polymer Emulsion B1

A reaction vessel equipped with a stirrer, a reflux condenser, a dropping funnel, and a thermometer was charged with 900 g of ion-exchanged water and 4 g of sodium laurylsulfate. The internal temperature of the reaction vessel was raised to 70° C. under a nitrogen atmosphere while stirring. While maintaining the internal temperature at 70° C., 2 g of potassium persulfate as a polymerization initiator was added to and dissolved in the solution in the reaction vessel. Separately, 450 g of ion-exchanged water, 3 g of sodium laurylsulfate, 20 g of acrylamide, 435 g of styrene, 475 g of butyl acrylate, 30 g of methacrylic acid, and 2 g of ethylene glycol dimethacrylate were previously added with stirring to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion B1 of fine particles of a polymer was cooled to room temperature, and ion-exchanged water and potassium hydroxide were then added to the polymer emulsion to bring the solid content to 35% by weight and the pH value to 8. The polymer emulsion of fine particles of a polymer thus obtained had a minimum film-forming temperature of 22° C., a surface tension of 53×10⁻³ N/m (53 dynes/cm), a contact angle of 83 degrees, an average particle diameter of 100 nm, and a half-value period in a reaction with Mg²⁺ion of 150 sec.

### Polymer Emulsion B2

A reaction vessel equipped with a stirrer, a reflux condenser, a dropping funnel, and a thermometer was charged with 900 g of ion-exchanged water and 4 g of sodium laurylsulfate. The internal temperature of the reaction vessel was raised to 70° C. under a nitrogen atmosphere while stirring. While maintaining the internal temperature at 70° C., 2 g of potassium persulfate as a polymerization initiator was added to and dissolved in the solution in the reaction vessel. Separately, 450 g of ion-exchanged water, 3 g of sodium laurylsulfate, 20 g of acrylamide, 435 g of styrene, 475 g of butyl acrylate, 30 g of methacrylic acid, and 40 g of ethylene glycol dimethacrylate were previously added with stirring to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion thus obtained was cooled to room temperature, and ion-exchanged water and sodium hydroxide were then added to the polymer emulsion to bring the solid content to 35% by weight and the pH value to 8. The aqueous emulsion B2 of fine particles of a polymer thus obtained had a minimum film-forming temperature of 22° C., a surface tension of 57×10⁻³ N/m (57 dynes/cm), a contact angle of 95 degrees, an average particle diameter of 102 nm, and a half-value period in a reaction with Mg^{2 +}ion of 90 sec.

### Polymer Emulsion B3

A reaction vessel equipped with a stirrer, a reflux condenser, a dropping funnel, and a thermometer was charged with 900 g of ion-exchanged water and 4 g of sodium laurylsulfate. The internal temperature of the reaction vessel was raised to 70° C. under a nitrogen atmosphere while stirring. While maintaining the internal temperature at 70° C., 2 g of potassium persulfate as a polymerization initiator was added to and dissolved in the solution in the reaction vessel. Separately, 450 g of ion-exchanged water, 3 g of sodium laurylsulfate, 20 g of acrylamide, 435 g of styrene, 475 g of butyl acrylate, 30 g of methacrylic acid, and 10 g of ethylene glycol dimethacrylate were previously added with stirring to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion thus obtained was cooled to room temperature, and ion-exchanged water and sodium hydroxide were then added to the polymer emulsion to bring the solid content to 35% by weight and the pH value to 8. The polymer emulsion B3 of fine particles of a polymer thus obtained had a minimum film-forming temperature of 22° C., a surface tension of 54×10⁻³ N/m (54 dynes/cm), a contact angle of 85 degrees, an average particle diameter of 101 nm, and a half-value period in a reaction with Mg²⁺ ion of 134 sec.

### Polymer Emulsion B4

A reaction vessel equipped with a stirrer, a reflux condenser, a dropping funnel, and a thermometer was charged with 900 g of ion-exchanged water and 4 g of sodium laurylsulfate. The internal temperature of the reaction vessel was raised to 70° C. under a nitrogen atmosphere while stirring. While maintaining the internal temperature at 70° C., 2 g of potassium persulfate as a polymerization initiator was added to and dissolved in the solution in the reaction vessel. Separately, 450 g of ion-exchanged water, 3 g of sodium laurylsulfate, 20 g of acrylamide, 435 g of styrene, 475 g of butyl acrylate, 30 g of methacrylic acid, and 10 g of tetraethylene glycol dimethacrylate were previously added with stirring to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion thus obtained was cooled to room temperature, and ion-exchanged water and sodium hydroxide were then added to the polymer emulsion to bring the solid content to 35% by weight and the pH value to 8. The polymer emulsion of fine particles of a polymer thus obtained had a minimum film-forming temperature of 22° C., a surface tension of 51×10⁻³ N/m (51 dynes/cm), a contact angle of 80 degrees, an average particle diameter of 190 nm, and a half-value period in a reaction with Mg²⁺ ion of 3860 sec.

### Polymer Emulsion B5

A reaction vessel equipped with a stirrer, a reflux condenser, a dropping funnel, and a thermometer was charged with 900 g of ion-exchanged water. The temperature of the ion-exchanged water in the reaction vessel was raised to 70° C. in a nitrogen atmosphere while stirring. While maintaining the internal temperature of the reaction vessel at 70° C., 2 g of potassium persulfate as a polymerization initiator was added to and dissolved in the ion-exchanged water. Separately, 53 g of styrene, 59 g of butyl acrylate, 48 g of glycidyl methacrylate, and 0.16 g of t-dodecylmercaptan as a molecular weight modifier were previously added to 70 g of ion-exchanged water and 1.0 g of sodium laurylsulfate while stirring to prepare an emulsification product. This emulsification product was continuously added dropwise to the contents of the reaction vessel over a period of one hr. After the completion of the dropwise addition of the emulsification product, the mixture was ripened for one hr. Separately, 79 g of styrene, 80 g of butyl acrylate, and 0.16 g of t-dodecylmercaptan were previously added to 70 g of ion-exchanged water, 1.0 g of sodium laurylsulfate, and 1 g of acrylamide while stirring to prepare an emulsification product. This emulsification product was continuously added dropwise to the contents of the reaction vessel over a period of one hr. After the completion of the dropwise addition of the emulsification product, the mixture was ripened at the same temperature for one hr. An aqueous solution of 2 g of ammonium persulfate as a polymerization initiator in 20 g of ion-exchanged water was added to the contents of the reaction vessel. Separately, 298 g of styrene, 297 g of butyl acrylate, 29 g of methacrylic acid, 10 g of ethylene glycol dimethacrylate, and 0.65 g of t-dodecylmercaptan were previously added with stirring to 300 g of ion-exchanged water, 2 g of sodium laurylsulfate, and 16 g of acrylamide to prepare an emulsification product. This emulsification product was continuously added dropwise to the contents of the reaction vessel over a period of 3 hr. After the completion of the dropwise addition of the emulsification product, the mixture was ripened at the same temperature. The polymer emulsion thus obtained was cooled to room temperature, and ion-exchanged water and potassium hydroxide were then added to the polymer emulsion to bring the solid content to 35% by weight and the pH value to 8. The polymer emulsion B5 of fine particles of a polymer thus obtained comprised fine particles of a polymer having a core-shell structure and an average particle diameter of 90 nm, and had a minimum film-forming temperature of 24° C., a surface tension of 58×10⁻³ N/m (58 dynes/cm), a contact angle of 108 degrees, an average particle diameter of 90 nm, and a half-value period in a reaction with Mg^{2 +} ion of 10 sec.

### Polymer Emulsion B6

A reaction vessel equipped with a stirrer, a reflux condenser, a dropping funnel, and a thermometer was charged with 900 g of ion-exchanged water. The temperature of the ion-exchanged water in the reaction vessel was raised to 70° C. in a nitrogen atmosphere while stirring. While maintaining the internal temperature of the reaction vessel at 70° C., 2 g of potassium persulfate as a polymerization initiator was added to and dissolved in the ion-exchanged water. Separately, 53 g of styrene, 59 g of butyl acrylate, 48 g of glycidyl methacrylate, and 0.16 g of t-dodecylmercaptan as a molecular weight modifier were previously added to 70 g of ion-exchanged water and 0.5 g of sodium laurylsulfate while stirring to prepare an emulsification product. This emulsification product was continuously added dropwise to the contents of the reaction vessel over a period of one hr. After the completion of the dropwise addition of the emulsification product, the mixture was ripened at the same temperature for one hr. Separately, 79 g of styrene, 80 g of butyl acrylate, and 0.16 g of t-dodecylmercaptan were previously added to 70 g of ion-exchanged water, 0.5 g of sodium laurylsulfate, and 1 g of acrylamide while stirring to prepare an emulsification product. This emulsification product was continuously added dropwise to the contents of the reaction vessel over a period of one hr. After the completion of the dropwise addition of the emulsification product, the mixture was ripened at the same temperature for one hr. An aqueous solution of 2 g of ammonium persulfate as a polymerization initiator in 20 g of ion-exchanged water was then added to the contents of the reaction vessel. Separately, 298 g of styrene, 297 g of butyl acrylate, 29 g of methacrylic acid, 10 g of tetraethylene glycol dimethacrylate, and 0.65 g of t-dodecylmercaptan were previously added with stirring to 300 g of ion-exchanged water, 2 g of sodium laurylsulfate, and 16 g of acrylamide to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion of fine particles of a polymer thus obtained was cooled to room temperature, and ion-exchanged water and potassium hydroxide were then added to the polymer emulsion to bring the solid content to 35% by weight and the pH value to 8. In the polymer emulsion B6 of fine particles of a polymer, the fine particles of a polymer had a core-shell structure. The polymer emulsion had a minimum film-forming temperature of 24° C., a surface tension of 55 ×10⁻³ N/m (55 dynes/cm), a contact angle of 92 degrees, an average particle diameter of 180 nm, and a half-value period in a reaction with Mg²⁺ ion of 3620 sec.

Polymer emulsion B7 (Comparative Example)

A reaction vessel equipped with a stirrer, a reflux condenser, a dropping funnel, and a thermometer was charged with 400 g of ion-exchanged water and 4 g of sodium laurylsulfate. The internal temperature of the reaction vessel was raised to 70° C. under a nitrogen atmosphere while stirring. While maintaining the internal temperature at 70° C., 1 g of potassium persulfate as a polymerization initiator was added to and dissolved in the solution in the reaction vessel. Separately, 470 g of butyl acrylate and 30 g of methacrylic acid were previously added with stirring to 300 g of ion-exchanged water and 3 g of sodium laurylsulfate to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion of fine particles of a polymer thus obtained was cooled to room temperature, and ion-exchanged water and ammonia were then added to the polymer emulsion to bring the solid content to 35% by weight and the pH value to 8. The polymer emulsion B7 of fine particles of a polymer thus obtained had a minimum film-forming temperature of 5° C. and an average particle diameter of 180 nm.

### Polymer Emulsion B8 (Comparative Example)

A reaction vessel equipped with a stirrer, a reflux condenser, a dropping funnel, and a thermometer was charged with 900 g of ion-exchanged water and 4 g of sodium laurylsulfate. The internal temperature of the reaction vessel was raised to 70° C. under a nitrogen atmosphere while stirring. While maintaining the internal temperature of the reaction vessel at 70° C., 2 g of potassium persulfate as a polymerization initiator was added to and dissolved in the solution in the reaction vessel. Separately, 435 g of styrene, 475 g of butyl acrylate, 30 g of methacrylic acid, and 60 g of ethylene glycol dimethacrylate were previously added with stirring to 450 g of ion-exchanged water, 3 g of sodium laurylsulfate, and 20 g of acrylamide to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion B8 of fine particles of a polymer thus obtained was cooled to room temperature, and ion-exchanged water and ammonia were then added to the polymer emulsion to bring the solid content to 35% by weight and the pH value to 8.

### Polymer Emulsion B9 (Comparative Example)

A reaction vessel equipped with a stirrer, a reflux condenser, a dropping funnel, and a thermometer was charged with 900 g of ion-exchanged water and 4 g of sodium laurylsulfate. The internal temperature of the reaction vessel was raised to 70° C. under a nitrogen atmosphere while stirring. While maintaining the internal temperature at 70° C., 2 g of potassium persulfate as a polymerization initiator was added to and dissolved in the solution in the reaction vessel. Separately, 435 g of styrene, 475 g of butyl acrylate, and 3 g of methacrylic acid were previously added with stirring to 450 g of ion-exchanged water and 3 g of sodium laurylsulfate to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion of fine particles of a polymer thus obtained was cooled to room temperature, and ion-exchanged water and ammonia were then added to the polymer emulsion to bring the solid content to 35% by weight and the pH value to 8. The polymer emulsion B9 of fine particles of a polymer thus obtained had a minimum film-forming temperature of 12° C., a surface tension of 37×10⁻³ N/m (37 dynes/cm), a contact angle of 60 degrees, and an average particle diameter of 150 nm.

### Polymer Emulsion B10 (Comparative Example)

A reaction vessel equipped with a stirrer, a reflux condenser, a dropping funnel, and a thermometer was charged with 300 g of ion-exchanged water and 4 g of sodium laurylsulfate. The internal temperature of the reaction vessel was raised to 70° C. under a nitrogen atmosphere while stirring. While maintaining the internal temperature at 70° C., 1 g of potassium persulfate as a polymerization initiator was added to and dissolved in the solution in the reaction vessel. Separately, 260 g of styrene, 47.5 g of butyl acrylate, and 2 g of methacrylic acid were previously added with stirring to 100 g of ion-exchanged water and 0.3 g of sodium laurylsulfate, and 2 g of acrylamide to prepare an emulsification product. This emulsification product was continuously added dropwise to the contents of the reaction vessel over a period of 3 hr. After the completion of the dropwise addition of the emulsification product, the mixture was ripened at the same temperature for 3 hr. The polymer emulsion of fine particles of a polymer thus obtained was cooled to room temperature, and ion-exchanged water and ammonia were then added to the polymer emulsion to bring the solid content to 35% by weight and the pH value to 8. The polymer emulsion B10 of fine particles of a polymer thus obtained had a minimum film-forming temperature of 75° C. and an average particle diameter of 120 nm.

### Impartation of Hydrophilic Group onto Surface of Pigment: B

### Black Pigment B1

A commercially available acidic carbon Black (MA-100, manufactured by Mitsubishi Chemical Corporation) was thoroughly mixed in an amount of 300 g with 1,000 ml of water, and 450 g of sodium hypochlorite (available chlorine 12%) was added dropwise to the mixture, followed by stirring at 80° C. for 15 hr. The resultant slurry was filtered through Toyo filter paper No. 2, and the pigment particles were then repeatedly washed with ion-exchanged water. The washing with water was carried out until, when a 0.1 N aqueous solution of silver nitrate was added to the ion-exchanged water, which has been passed through the filter paper, the filtrate no longer became opaque. This pigment wet cake thus obtained was redispersed in 2500 ml of water. The dispersion was desalted through a reverse osmosis membrane to an electrical conductivity of not more than 0.2 mS. Further, the pigment dispersion was concentrated to a pigment concentration of about 15% by weight. The resultant surface treated pigment dispersion was treated with an acid (acidified with aqueous hydrochloric acid), was concentrated, was dried, and was pulverized to prepare a powder. The surface active hydrogen content of this powder of surface treated carbon black was measured by a method described later, and was found to be 2.8 mmol/g.

### Black Pigment B2

Carbon black (“MA-7,” manufactured by Mitsubishi Chemical Corporation) (15 parts) was mixed with 200 parts of sulfolane, and the mixture was dispersed in Eiger Motor Mill (model M 250, manufactured by Eiger Japan) under conditions of percentage beads packing 70% and rotation speed 5000 rpm for one hr. A mixture of the pigment paste, subjected to dispersion, with a solvent was transferred to an evaporator, and heated to 120° C. while reducing the pressure to not more than 30 mmHg to distil away water contained in the system as much as possible. Thereafter, the temperature of the system was regulated to 150° C. Sulfur trioxide (25 parts) was then added to the residue, and a reaction was allowed to proceed for 6 hr. After the completion of the reaction, the reaction product was washed several times with an excess of sulfolane, and was then poured into water, followed by filtration to prepare a black pigment. The amount of the hydrophilic group introduced into the black pigment was 120×10⁻⁶ equivalents per g of the pigment.

### Cyan Pigment B

A phthalocyanine pigment (C.I. Pigment Blue 15 : 3) (20 parts) was mixed with 500 parts of quinoline, and the mixture was dispersed in Eiger Motor Mill (model M 250, manufactured by Eiger Japan) under conditions of percentage beads packing 70% and rotation speed 5000 rpm for 2 hr. A mixture of the pigment paste, subjected to dispersion, with a solvent was transferred to an evaporator, and heated to 120° C. while reducing the pressure to not more than 30 mmHg to distil away water contained in the system as much as possible. Thereafter, the temperature of the system was regulated to 160° C. Subsequently, 20 parts of a sulfonated pyridine complex was added thereto, and a reaction was allowed to proceed for 8 hr. After the completion of the reaction, the reaction product was washed several times with an excess of quinoline, and was then poured into water, followed by filtration to prepare a cyan pigment having a hydrophilic group on its surface. The amount of the hydrophilic group introduced into the cyan pigment was 40×10⁻⁶ equivalents per g of the pigment.

### Yellow Pigment B

The same treatment as described in connection with the cyan pigment B was carried out, except that “20 parts of an isoindolinone pigment (C.I. Pigment Yellow 110)” was used instead of “20 parts of the phthalocyanine pigment (C.I. Pigment Blue 15:3).” Thus, a yellow pigment having a hydrophilic group on its surface was prepared. The amount of the hydrophilic group introduced into the yellow pigment was 45×10⁻⁶ equivalents per g of the pigment.

### Magenta Pigment B

The same treatment as described in connection with the cyan pigment B was carried out, except that “20 parts of an isoindolinone pigment (C.I. Pigment Red 122)” was used instead of “20 parts of the phthalocyanine pigment (C.I. Pigment Blue 15:3).” Thus, a magenta pigment having a hydrophilic group on its surface was prepared. The amount of the hydrophilic group introduced into the yellow pigment was 60×10⁻⁶ equivalents per g of the pigment.

### Quantitative Determination of Amount of Hydrophilic Group Introduced: B

The “amount of the hydrophilic group introduced into the surface of the pigment particles” was quantitatively determined by the following method.

1) Where Hydrophilic Group was Introduced by Using Carboxylating Agent

The amount of the hydrophilic group introduced was manually quantitatively determined by the Zeisel method. Diazomethane was dissolved in a proper solvent. This solution was added dropwise to exchange all of active hydrogen atoms, present on the surface of the pigment particles, with a methyl group. Thereafter, hydroiodic acid having a specific gravity of 1.7 was added thereto, and the mixture was heated to gasify the methyl group as methyl iodide. This gas of methyl iodide was trapped in a silver nitrate solution and consequently was precipitated as methylsilver iodide.

The amount of the original methyl group, that is, the amount of the active hydrogen, was determined from the weight of this silver iodide.

2) Where Hydrophilic Group was Introduced by Using Sulfonating Agent

Pigment particles, which had been surface treated with a sulfonating agent, were treated by the oxygen flask combustion method, followed by absorption into a 0.3% aqueous hydrogen peroxide solution. Thereafter, the amount of sulfate ions (divalent) was quantitatively determined by ion chromatography (DIONEX; 2000i), and was then converted to the amount of the sulfonic acid group to express the amount of the hydrophilic group in terms of equivalent per g of the pigment.

### Preparation of Ink Compositions: B

Ink compositions of Examples B1 to B6 and Comparative Examples B1 to B6 were prepared according to formulations shown in Table B1. In the preparation of ink, predetermined amounts of water, the penetrating agent, the wetting agent, the solid wetting agent, and other additives indicated in Table B1 were added, mixed together, and dissolved in one another to prepare a solution which was then gradually added to a predetermined amount of a polymer emulsion comprising fine particles of a polymer as dispersed particles while stirring. The mixed liquid thus obtained was gradually added dropwise to the dispersion of pigment having on its surface a hydrophilic group prepared above, followed by thorough stirring. The stirred liquid was filtered through a 5 μm membrane filter to prepare an ink composition. In Table B1, the amount of the fine particles of a polymer added was calculated from the solid content of the polymer emulsion containing the fine particles of the polymer as dispersed particles.

TABLE B1

| | Ex. | Ex. | Ex. | Ex. | Ex. | Ex. | Ex. | Ex. | Comp. | Comp. | Comp. | Comp. |
|---|---|---|---|---|---|---|---|---|---|---|---|---|
| | B1 | B2 | B3 | B4 | B5 | B6 | B7 | B8 | Ex. B1 | Ex. B2 | Ex. B3 | Ex. B4 |
| Black pigment B1 | 7 | | | | | 7 | 7 | 7 | 7 | | 7 | |
| Black pigment B2 | | 7 | | | | | | | | 7 | | 7 |
| Cyan pigment B | | | 6 | | | | | | | | | |
| Yellow pigment B | | | | 6 | | | | | | | | |
| Magenta pigment B | | | | | 6 | | | | | | | |
| Polymeric fine particles B1 | 4 | | | | | | 4 | 4 | | | | |
| Polymeric fine particles B2 | | 4 | | | | | | | | | | |
| Polymeric fine particles B3 | | | 3 | | | | | | | | | |
| Polymeric fine particles B4 | | | | 3 | | | | | | | | |
| Polymeric fine particles B5 | | | | | 3 | | | | | | | |
| Polymeric fine particles B6 | | | | | | 4 | | | | | | |
| Polymeric fine particles B7 | | | | | | | | | 4 | | | |
| Polymeric fine particles B8 | | | | | | | | | | 4 | | |
| Polymeric fine particles B9 | | | | | | | | | | | 4 | |
| Polymeric fine particles B10 | | | | | | | | | | | | 4 |
| 1,2-Hexanediol | 5 | 5 | 5 | 3 | 5 | 5 | 5 | 5 | 5 | 5 | 5 | 5 |
| 1,2-Pentanediol | | | | 3 | | | | | | | | |
| Diethylene glycol monobutyl ether | | 3 | | | | 2 | | 3 | | 3 | | 3 |
| Triethylene glycol monobutyl ether | | | 3 | | 3 | | 3 | | 3 | | 3 | |
| Olfine E 1010 | 1 | 1 | 1 | 1 | 1 | 1 | 1 | 1 | | 1 | 1 | 1 |
| Glycerin | 15 | 12 | 10 | 12 | 12 | 10 | | 15 | 15 | 12 | 15 | 15 |
| Trimethylene glycol | | | 3 | | | 2 | | | | | | |
| Maltitol | 3 | | | | 5 | 3 | | | 5 | | 5 | |
| Xylitol | | 5 | 3 | 3 | | | | | | 5 | | 5 |
| 1% aqueous sodium hyaluronate solution | 1 | 1 | | | 1 | | | | | 1 | | |
| Trimethylolpropane | | 1 | 3 | | 1 | | | | | 1 | | |
| 1,2,6-Hexanetriol | | | | 3 | | | | | | | | |
| 2-Pyrrolidone | 2 | 2 | 2 | 2 | 2 | 2 | 2 | 2 | 2 | 2 | 2 | 2 |
| Sodium hydroxide | q.s. | q.s. | q.s. | q.s. | q.s. | q.s. | q.s. | q.s. | q.s. | q.s. | q.s. | q.s. |
| Potassium hydroxide | q.s. | q.s. | q.s. | q.s. | q.s. | q.s. | q.s. | q.s. | q.s. | q.s. | q.s. | q.s. |
| Ion-exchanged water | Bal- | Bal- | Bal- | Bal- | Bal- | Bal- | Bal- | Bal- | Bal- | Bal- | Bal- | Bal- |
| | ance | ance | ance | ance | ance | ance | ance | ance | ance | ance | ance | ance |

### Evaluation Tests of Ink Compositions: B

For the ink compositions prepared in Table B1, the following ink evaluation tests were carried out. An ink jet printer PM-980 C manufactured by Seiko Epson Corporation was used for printing. The following papers were used for printing tests. The results of evaluation of the evaluation items were as summarized in Table B2.

Xerox P, manufactured by Xerox Corp.

Ricopy 6200, manufactured by Ricoh Co., Ltd.

Xerox 4024, manufactured by Xerox Corp.

Neenah Bond, manufactured by Kimberly-Clark

Xerox R (recycled paper), manufactured by Xerox Corp.

Yamayuri (recycled paper), manufactured by Honshu Paper Co., Ltd.

### Evaluation B1: Rubbing/scratch Resistance (Line Marker Resistance)

Prints were air dried for 24 hr, and the printed characters were then rubbed with a water-base yellow fluorescent marker pen (ZEBRA PEN 2 (trademark)) manufactured by ZEBRA at a marking force of 4.9×10⁵ N/m², followed by visual inspection for staining. The results were evaluated according to the following criteria.

A: Rubbing twice caused no stain.

B: For some of the papers, rubbing twice caused stain, although rubbing once caused no stain.

C: For some of the papers, rubbing once caused stain.

### Evaluation B2: Anti-clogging Property

Alphameric characters were continuously printed for 10 min. Thereafter, the printer was stopped, and was allowed to stand for one week without capping under an environment of temperature 40° C. and humidity 25%. After the standing, alphameric characters were printed again to determine the number of cleaning operations necessary for print quality equal to that before the standing to be obtained. The results were evaluated according to the following criteria.

A: 0 to 2 cleaning operations

B: 3 to 5 cleaning operations

C: 6 or more cleaning operations

### Evaluation B3: Ejection Stability

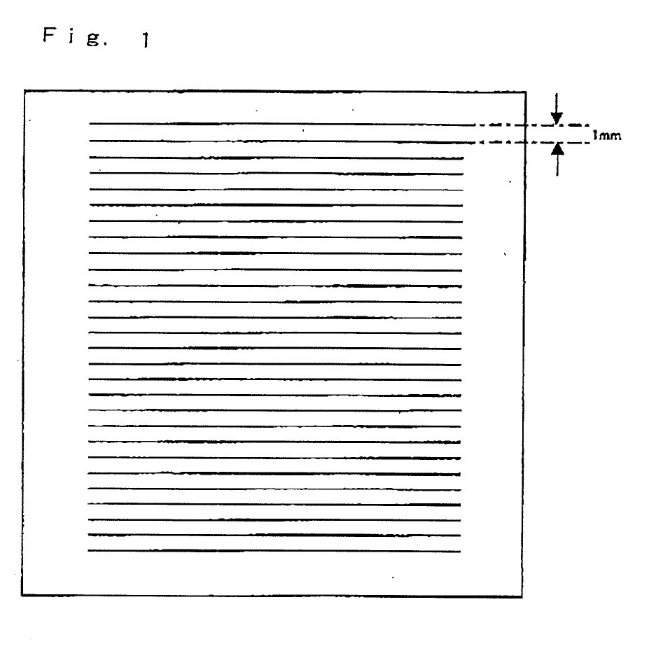

For each of the ink compositions, a pattern of ruled lines provided at spacings of 1 mm (see FIG. 1) was printed on 1000 sheets of Superfine Paper (manufactured by Seiko Epson Corporation) by means of an ink jet printer EM-900 C (manufactured by Seiko Epson Corporation). The ejection stability of ink from a recording head was evaluated according to the following criteria.

A: For all the 1000 sheets, no curved ruled line occurred.

B: For the 1000 sheets, curved ruled lines sometimes occurred, and less than 5 cleaning operations were necessary for return to normal printing of ruled lines.

C: For the 1000 sheets, curved ruled lines frequently occurred, and 5 or more cleaning operations were necessary for return to normal printing of ruled lines.

### Evaluation B4: Printing Quality (Feathering)

Characters were printed using the ink compositions, and the prints were dried and were then evaluated for feathering of the characters in the prints according to the following criteria.

A: Although slight feathering was observed for some papers, sharp printed images could be formed for the other papers.

B: For all the papers, feathering occurred.

C: Feathering occurred on a level such that the outline of characters was unclear.

### Evaluation B5: Print Density

Blotted images were printed using the ink compositions on wood-free plain paper KA 4250 NP (manufactured by Seiko Epson Corporation) by means of an ink jet printer EM-900 C (manufactured by Seiko Epson Corporation). The density of the printed portion in the prints was measured with a spectrophotometer (GRETAG SPM-50, manufactured by Gretag Macbeth). The results were evaluated according to the following criteria.

A: OD value of black ink was not less than 1.4, and OD value of color ink was not less than 1.2.

B: OD value of black ink was 1.3 to less than 1.4, and OD value of color ink was 1.15 to less than 1.2.

C: OD value of black ink was less than 1.3, and OD value of color ink was less than 1.15.

### Evaluation B6: Storage Stability

The ink compositions (50 cc) were placed in glass bottles. The bottles were hermetically sealed, and allowed to stand at 60° C. for two weeks. After the standing, each ink composition was inspected for a change in viscosity and the presence of sediment. The results were evaluated according to the following criteria.

A: There was neither sediment nor a change in viscosity.

B: There was a slight change in viscosity (less than 1.0 cps), although no sediment occurred.

C: There was a change in viscosity, although no sediment occurred.

D: Sediment occurred.

### Evaluation B7: Fast Drying Property

Blotted images (100% duty) were printed using the ink compositions on Xerox P in its region having a size of 10 mn×10 mm by means of an ink jet printer MJ-930 C (manufactured by Seiko Epson Corporation). Ten seconds after the printing, a new sheet of the same paper was placed on the printed portion, and a weight of 300 g was applied to the printed portion through the new sheet, followed by standing for 10 sec. Thereafter, the new sheet was removed, and was inspected for the deposition of ink. The results were evaluated according to the following criteria.

A: Deposition of ink did not occur.

B: Deposition of ink occurred.

TABLE B2

| | | | Ex. | Ex. | Ex. | Ex. | Ex. | Ex. | Ex. | Ex. | Comp. | Comp. | Comp. | Comp. |
|---|---|---|---|---|---|---|---|---|---|---|---|---|---|---|
| | | | B1 | B2 | B3 | B4 | B5 | B6 | B7 | B8 | Ex. B1 | Ex. B2 | Ex. B3 | Ex. B4 |
| Evalu- | 1: | Rubbing/scratch | A | A | A | A | A | A | A | A | A | C | A | C |
| ation | | resistance (line | | | | | | | | | | | | |
| | | marker resistance) | | | | | | | | | | | | |
| | 2: | Anti-clogging | A | A | A | A | A | A | B | B | C | B | B | B |
| | | property | | | | | | | | | | | | |
| | 3: | Ejection stability | A | A | A | A | A | A | A | A | C | A | C | C |
| | 4: | Print quality | A | A | A | A | A | A | A | A | B | A | C | C |
| | | (feathering) | | | | | | | | | | | | |
| | 5: | Print density | A | A | A | A | A | A | A | A | C | A | B | C |
| | 6: | Storage stability | A | A | A | A | A | A | B | B | C | C | C | C |
| | 7: | Fast drying property | A | A | A | A | A | A | A | A | A | A | A | A |

1. A process for producing a polymer emulsion comprising fine particles of a polymer, said process comprising the steps of:
mixing water, a monomer, an emulsifier, and a polymerization initiator together to allow emulsion polymerization to proceed; and
adjusting pH of the resultant polymer emulsion to neutral or alkaline by adding a monovalent inorganic hydroxide.

2. The process according to claim 1, wherein the monovalent inorganic hydroxide is an alkali metal hydroxide.

3. The process according to claim 2, wherein the alkali metal hydroxide is one member or a mixture of two or more members selected from the group consisting of lithium hydroxide, sodium hydroxide, and potassium hydroxide.

4. The process according to claim 1, wherein the pH value is adjusted to 7 to 9.

5. The process according to claim 1, wherein the fine particles of the polymer contain 1 to 10% by weight of a structure derived from a carboxyl-containing unsaturated vinyl monomer, have a structure which is crosslinked by a crosslinkable monomer having two or more polymerizable double bonds, and contain 0.2 to 4% by weight of the structure derived from the crosslinkable monomer.

6. The process according to claim 1, wherein the fine particles of the polymer have a film-forming property, have on its surface a carboxyl group, and have a reactivity with a divalent metal salt such that, when 3 volumes of a polymer emulsion containing 0.1% by weight of the fine particles of the polymer is brought into contact with one volume of a 1 mol/liter aqueous divalent metal salt solution, the time required for the transmittance of light having a wavelength of 700 nm to become 50% of the initial transmittance value is not more than 1×10⁴ sec.

7. The polymer emulsion produced by the process according to any one of claims 1 to 6.

8. An ink composition comprising a pigment, a polymer emulsion, water, and a water-soluble organic solvent, said polymer emulsion being one according to claim 7.

9. The ink composition according to claim 8, wherein the content of the fine particles of the polymer constituting the polymer emulsion is 0.01 to 30% by weight based on the total amount of the ink composition.

10. The ink composition according to claim 8, wherein the pigment has on its surface a hydrophilic group.

11. The ink composition according to claim 10, wherein the pigment having on its surface a hydrophilic group is carbon black or an organic pigment.

12. The ink composition according to claim 10, wherein the hydrophilic group present on the surface of the pigment is a sulfonic acid group (—SO₂OH) and/or a sulfinic acid group (—RSO₂H wherein R represents a C₁ to c₁₂ alkyl group or a phenyl group or a derivative thereof).

13. The ink composition according to claim 10, wherein the hydrophilic group present on the surface of the pigment is a sulfonic acid anion group (—SO₃⁻) and/or a sulfinic acid anion group (—RSO₂ wherein R represents a C₁ to C₁₂ alkyl group or a phenyl group or a derivative thereof).

14. The ink composition according to claim 10, wherein the hydrophilic group present on particles of the pigment is a carboxylic acid group (—CO₂H) and/or a carboxylic acid anion group (—CO₂⁻).

15. The ink composition according to claim 8, which further comprises a penetrating agent or a wetting agent.

16. The ink composition according to claim 15, wherein the penetrating agent is one or more members selected from the group consisting of 1,2-alkyl diols, glycol ethers, acetylene glycol surfactants, and acetylene alcohol surfactants.

17. The ink composition according to claim 16, wherein the 1,2-alkyl diol is 1,2-hexanediol or 1,2-pentanediol.

18. The ink composition according to claim 16, wherein the glycol ether is one or more members selected from the group consisting of dialkylene glycol monobutyl ethers, dialkylene glycol monopentyl ethers, dialkylene glycol monohexyl ethers, trialkylene glycol monobutyl ethers, trialkylene glycol monopentyl ethers, trialkylene glycol monohexyl ethers, tetraalkylene glycol monobutyl ethers, tetraalkylene glycol monopentyl ethers, and tetraalkylene glycol monohexyl ethers.

19. The ink composition according to claim 15, wherein the wetting agent is glycerin or trimethylene glycol.

20. The ink composition according to claim 15, wherein the content of the wetting agent is 10 to 20% by weight based on the total amount of the ink composition.

21. The ink composition according to claim 15, wherein the wetting agent is a solid wetting agent.

22. The ink composition according to claim 21, wherein the content of the solid wetting agent is 3 to 20% by weight based on the total amount of the ink composition.

23. The ink composition according to claim 21, wherein the solid wetting agent has the function of retaining water and is a water-soluble material which is solid at room temperature (25° C.).

24. The ink composition according to claim 21, wherein the solid wetting agent is one or more members selected from the group consisting of saccharides, sugar alcohols, hyaluronic acid, trimethylolpropane, and 1,2,6-hexanetriol.

25. The ink composition according to claim 8, which further comprises, as a pH adjustor, one or more members selected from the group consisting of potassium hydroxide, sodium hydroxide, and lithium hydroxide.

26. A recording method comprising the step of: depositing an ink composition onto a recording medium to perform printing, said ink composition being one according to any one of claims 8 to 25.

27. The recording method according to claim 26, which is an ink jet recording method comprising the steps of: ejecting droplets of an ink composition; and depositing the droplets onto a recording medium to perform printing.

28. A record printed by the recording method according to claim 27.
